(19) United States
(12) Patent Application Publication
(10) Pub. No.: US 2009/0203439 A1
(43) Pub. Date: Aug. 13, 2009

(54) Gaming Device Giving Player Choice Of Character And Playing Method Thereof

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 12/139,949

(22) Filed: Jun. 16, 2008

Related U.S. Application Data
(60) Provisional application No. 61/027,167, filed on Feb. 8, 2008.

(51) Int. Cl. G06F 17/00

(52) U.S. Cl. 463/31; 463/43

(57) ABSTRACT

A gaming device includes a plurality of different characters and voice patterns associated therewith, a microphone, and a speaker. The gaming device requests a player to select a character other than one selected. During a game, there is output from the speaker a voice having a voice pattern associated with the selected character, based on an input to the microphone.

### CROSS REFERENCE TO RELATED APPLICATION

The present application claims priority from Provisional Application No. 61/027,167, which was filed on Feb. 8, 2008, the entire disclosure of which is herein incorporated by reference.

### BACKGROUND OF THE INVENTION

1. Field of the Invention

The present invention relates to a gaming device and a playing method thereof.

2. Description of Related Art

A gaming device which allows a plurality of players to play a game by placing a bet from a client terminal. For example, US2005/0059474 A1, US2005/0282618 A1 and US2005/0218590 A1 disclose a gaming machine having a plurality of consoles, a central controller, and a common display unit connected which are connected to one another.

Such a gaming device allows client terminals thereof to run games independently from one another. Each of the client terminals has at least one game that can be run therein.

Such a gaming device allows client terminals thereof to run games independently from one another. Each of the client terminals has at least one game that can be run therein.

The present invention provides a slot machine having entertainment characteristic, which is not provided to the conventional gaming machine, and a playing method thereof.

Further, the present invention provides a suitable gaming environment whereby players are not confused by game-related voices having an identical voice pattern output at the same time.

### SUMMARY OF THE INVENTION

In a first aspect of the present invention, a gaming device includes:

a voice pattern memory which stores therein a plurality of different voice patterns;

a character memory which stores therein a plurality of characters related to the games, the characters respectively associated with the voice patterns;

a speaker which outputs a voice related to the games to the outside;

a microphone which receives a voice externally input;

a plurality of terminal devices which runs therein a game;

a character selecting device which allows a player to select a character;

a controller which is programmed to perform the processes of:

(a1) determining if a character is selected and what character is selected in each of the terminal devices;

(a2) requesting the player to select through the character selecting device a character other than that being selected in the terminal devices, based on a result of (a1);

(a3) outputting from a speaker a voice having a voice pattern associated with a selected character, in relation to a game running in the targeted terminal device, based on an input to the microphone, information pieces stored in the character memory and voice pattern memory, and a game-running status.

According to the first aspect, the character selecting device requests the player to select a character from the plurality of characters respectively associated with different voice patterns. The targeted terminal device runs a game. There is determined if a character is selected and what character is selected in each of the terminal devices. Based on the character selection status determined, the character selecting device requests the player to select a character other than one selected in the terminal device. Based on an input to the microphone, information pieces stored in the character memory and voice pattern memory, and a game-running status, a voice having a selected voice pattern associated with a character is output from the speaker in relation to a game running in the targeted terminal device. Thus, the player is requested to select a character other than one selected in a terminal device within a predetermined distance from a terminal device to run a player-selected game, at the time of selecting a character from the plurality of characters. It is therefore possible to avoid outputting, from the speakers of these terminal devices, a game-related voice having an identical voice pattern associated with a single character. Thus, it is possible to provide a suitable gaming environment whereby players are not confused by outputting at the same time game-related voices having an identical voice pattern. Further, voice patterns are respectively associated with characters. This enables the player to easily make his/her selection of a voice pattern.

In a second aspect of the present invention, a gaming machine includes:

a voice pattern memory which stores therein a plurality of different voice patterns;

a character memory which stores therein a plurality of characters related to the games, the characters respectively associated with the voice patterns;

a plurality of terminal devices which runs the games, and each of which includes a speaker for outputting voices related to the games, and a microphone for receiving voice externally input;

a character selecting device which allows a player to select a character in one of the terminal devices;

a terminal position memory which stores a position of each of the terminal devices;

a controller which is programmed to perform the processes of:

(b1) determining if a character is selected and what character is selected in each of the terminal devices;

(b2) requesting the player to select a character other than one selected in a terminal device located within a predetermined distance from the targeted terminal device for running the player-selected game, based on a result of (b1) and information stored in the terminal position memory;

(b3) outputting from a speaker a voice having a voice pattern associated with a selected character, in relation to a game running in the targeted terminal device, based on an input to the microphone, information pieces stored in the character memory and voice pattern memory, and a game-running status.

According to the second aspect, the character selecting device requests the player to select a character from the plurality of characters respectively associated with different voice patterns. The targeted terminal device runs a game. There is determined if a character is selected and what character is selected in each of the terminal devices. Based on the character selection status determined and information stored in the terminal position memory, the character selecting device requests the player to select a character other than one selected in a terminal device located within the predetermined distance from a terminal device for running therein the player-selected game. Based on an input to the microphone, information pieces stored in the character memory and voice pattern memory, and a game-running status, a voice having a selected voice pattern associated with a character is output from the speaker in relation to a game running in the targeted terminal device. Thus, the player is requested to select a character other than one selected in a terminal device within a predetermined distance from a terminal device to run a player-selected game, at the time of selecting a character from the plurality of characters. It is therefore possible to avoid outputting, from speakers located within a predetermined distance from each other, a game-related voice having an identical voice pattern associated with a single character. Thus, it is possible to provide a suitable gaming environment whereby players are not confused by outputting within a predetermined distance game-related voices having an identical voice pattern at the same time. Further, voice patterns are respectively associated with characters. This enables the player to easily make his/her selection of a voice pattern. Although speakers located within a predetermined distance from each other are prohibited from outputting a game-related voice having an identical voice pattern associated with a single character at the same time, a game-related voice having the same voice pattern can be output at the same time from a speaker outside of the predetermined distance. The player therefore is provided with a larger selection of selectable characters, and more enjoyable gaming environment.

In a third aspect of the present invention, a gaming device includes:

a voice pattern memory which stores therein a plurality of different voice patterns;

a character memory which stores therein a plurality of characters related to the games, the characters respectively associated with the voice patterns;

a plurality of terminal devices which runs the games, and each of which includes a speaker for outputting voices related to the games, and a microphone for receiving voice externally input;

a character selecting device which allows a player to select a character;

a controller which is programmed to perform the processes of:

(c1) determining if a character is selected and what character is selected in a terminal device located within a voice-reachable distance, based on an input to the microphone and information stored in the voice pattern memory and character memory;

(c2) requesting the player to select through the character selecting device a character other than one selected in a terminal device located within the voice-reachable distance, based on a result of (c1);

(c3) outputting from a speaker a voice having a voice pattern associated with a selected character, in relation to a game running in the targeted terminal device, based on an input to the microphone, information pieces stored in the character memory and voice pattern memory, and a game-running status.

According to the third aspect, the character selecting device requests the player to select a character from the plurality of characters respectively associated with different voice patterns. The targeted terminal device runs a game. Based on an input to the microphone and information in the voice pattern memory and character memory, there is determined if a character is selected and what character is selected in a terminal device located within the voice-reachable distance. Based on the character selection status determined, the character selecting device only allows the player to select a character other than one selected in a terminal device located within the voice-reachable distance. Based on an input to the microphone, information pieces stored in the character memory and voice pattern memory, and a game-running status, a voice having a selected voice pattern associated with a character is output from the speaker in relation to a game running in the targeted terminal device. Thus, the player is requested to select a character other than one selected in a terminal device located within the voice-reachable distance, at the time of selecting a character from the plurality of characters. It is therefore possible to avoid outputting, from speakers located within the voice-reachable distance from each other, a game-related voice having an identical voice pattern associated with a single character. Thus, it is possible to provide a suitable gaming environment whereby players are not confused by outputting, within the voice-reachable distance, game-related voices having an identical voice pattern at the same time. Further, voice patterns are respectively associated with characters. This enables the player to easily make his/her selection of a voice pattern. Although speakers located within the voice-reachable from each other are prohibited from outputting game-related voices having an identical voice pattern associated with a single character at the same time, a game-related voice having the same voice pattern can be output at the same time from a speaker outside of the predetermined distance. The player therefore is provided with a larger selection of selectable characters, and more enjoyable gaming environment. Further, since speakers within the voice-reachable distance from each other are prohibited from outputting game-related voices having an identical voice pattern associated with a single character, the selection of characters provided to the player is more appropriately increased. This is advantageous in that there is no need for setting such a distance that speakers located within the distance from each other are prohibited from outputting game-related voices having an identical voice pattern associated with a single character. As a result, more enjoyable gaming environment is provided.

In a fourth aspect of the present invention, a gaming device includes:

a voice pattern memory which stores therein a plurality of different voice patterns;

a character memory which stores therein a plurality of characters related to the games, the characters respectively associated with the voice patterns;

a speaker which outputs a voice related to the games to the outside;

a microphone which receives a voice externally input;

a character selecting device which allows a player to select a character;

a controller which is programmed to perform the processes of:

(d1) determining if a character is selected and what character is selected in a gaming device located within a voice-reachable distance, based on an input to the microphone and information stored in the voice pattern memory and character memory;

(d2) requesting the player to select through the character selecting device a character other than one selected in a gaming device located within the voice-reachable distance, based on a result of (d1);

(d3) outputting a voice having a voice pattern associated with a selected character, in relation to a game running in the targeted terminal device, based on an input to the microphone, information pieces stored in the character memory and voice pattern memory, and a game-running status.

According to the fourth aspect, the character selecting device requests the player to select a character from the plurality of characters respectively associated with different voice patterns. Based on an input to the microphone and information in the voice pattern memory and character memory, there is determined if a character is selected and what character is selected in a gaming device located within the voice-reachable distance. Based on the character selection status determined, the character selecting device only allows the player to select a character other than one selected in a gaming device located within the voice-reachable distance. Based on an input to the microphone, information pieces stored in the character memory and voice pattern memory, and a game-running status, a voice having a selected voice pattern associated with a character is output from the speaker in relation to a game running. Thus, the player is requested to select a character other than one selected in a gaming device located within the voice-reachable distance, at the time of selecting a character from the plurality of characters. It is therefore possible to avoid outputting, from speakers located within the voice-reachable distance from each other, a game-related voice having an identical voice pattern associated with a single character. Thus, it is possible to provide a suitable gaming environment whereby players are not confused by outputting, within the voice-reachable distance, game-related voices having an identical voice pattern at the same time. Further, voice patterns are respectively associated with characters. This enables the player to easily make his/her selection of a voice pattern. Although speakers located within the voice-reachable from each other are prohibited from outputting game-related voices having an identical voice pattern associated with a single character at the same time, a game-related voice having the same voice pattern can be output at the same time from a speaker outside of the predetermined distance. The player therefore is provided with a larger selection of selectable characters, and more enjoyable gaming environment. Further, since speakers within the voice-reachable distance from each other are prohibited from outputting game-related voices having an identical voice pattern associated with a single character, the selection of characters provided to the player is more appropriately increased. This is advantageous in that there is no need for setting such a distance that speakers located within the distance from each other are prohibited from outputting game-related voices having an identical voice pattern associated with a single character. As a result, more enjoyable gaming environment is provided.

In a fifth aspect of the present invention, a playing method of a gaming device by which games are executed in a plurality of terminal devices,

the method comprising the steps of:

(e1) determining if a character is selected and what character is selected in each of the terminal devices;

(e2) requesting the player to select a character other than that being selected in the terminal devices, based on a result of (e1);

(e3) running the player-selected character game in the targeted terminal devices;

(e4) outputting from the speaker a voice having a voice pattern associated with a selected character, in relation to the game to be run in the targeted terminal device, based on an input to the microphone.

According to the fifth aspect, the player is requested to select a character from the plurality of characters respectively associated with different voice patterns. The targeted terminal device runs a game. There is determined if a character is selected and what character is selected in each of the terminal devices. Based on the character selection status determined, the player is requested to select a character other than one selected in the terminal devices. Based on an input to the microphone, a voice having a selected voice pattern associated with a selected character is output from the speaker in relation to a game running in the targeted terminal device. Thus, the player is requested to select a character other than one selected in a terminal device within a predetermined distance from a terminal device to run a player-selected game, at the time of selecting a character from the plurality of characters. It is therefore possible to avoid outputting, from the speakers of these terminal devices, a game-related voice having an identical voice pattern associated with a single character. Thus, it is possible to provide a suitable gaming environment whereby players are not confused by outputting at the same time game-related voices having an identical voice pattern. Further, voice patterns are respectively associated with characters. This enables the player to easily make his/her selection of a voice pattern.

### BRIEF DESCRIPTION OF THE DRAWINGS

FIG. 1 includes a perspective view of a gaming device 10 of Embodiment 1 according to the present invention, and an explanatory diagram showing a playing method of the gaming device.

FIG. 2 is a block diagram showing the gaming device of Embodiment 1.

FIG. 3 is an explanatory diagram showing a flow of the playing method of the gaming device 10.

FIG. 4 is an explanatory diagram showing a relation between a character selection status and a selection of a character in Embodiment 1.

FIG. 5 is an explanatory diagram showing a relation between a character selection status and a selection of a character in Embodiment 1.

FIG. 6 is an explanatory diagram showing a relation between a character selection status and a selection of a character in Embodiment 2.

FIG. 7 is a block diagram showing an electrical configuration of a gaming machine main body 1 of Embodiment 1.

FIG. 8 is a block diagram showing an electrical configuration of a terminal device 400 of Embodiment 1.

FIG. 9 is an explanatory diagram showing a terminal device position table of Embodiment 1.

FIG. 10 is an explanatory diagram showing a terminal device administration table of Embodiment 1.

FIG. 11 is an explanatory diagram showing a character data table of Embodiment 1.

FIG. 12 is a flowchart showing a main body end process routine of Embodiment 1.

FIG. 13 is a flowchart showing a terminal end process routine executed by the terminal device 400 of Embodiment 1.

FIG. 14 is a flowchart showing a selectable character determination routine of Embodiment 1.

FIG. 15 is an explanatory diagram showing a selected character administration table of Embodiment 2.

FIG. 16 is a flowchart showing a selectable character determination routine of Embodiment 2.

FIG. 17 is a flowchart showing a selected character determination routine of Embodiment 2.

FIG. 18 is a block diagram showing a gaming device of Embodiment 3, in accordance with the present invention.

### DESCRIPTION OF THE PREFERRED EMBODIMENTS

### Embodiment 1

The following describes a gaming device of Embodiment 1 according to the present invention, and a playing method thereof.

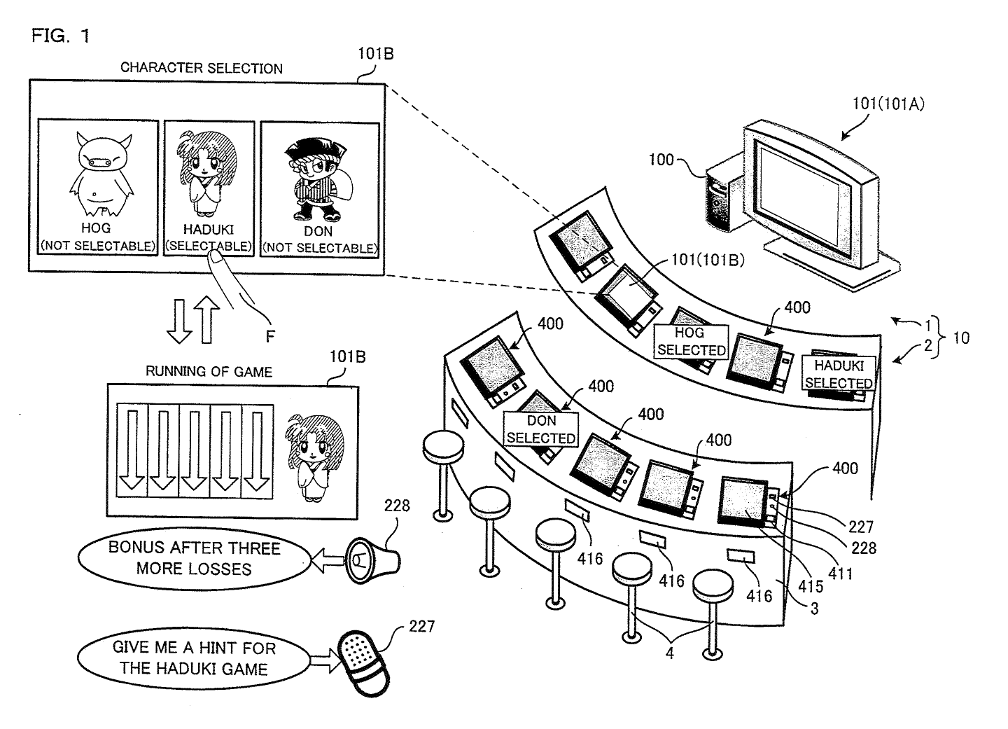

As shown in FIG. 1, a gaming device 10 executes a playing method including: a stage for determining if a character is selected and which character is selected in terminal devices 400; a stage for requesting a player to select through a character selecting device 111 a character other than one selected in a terminal device 400 located within a predetermined distance from a terminal device 400 (hereinafter, targeted terminal device) for running a player-selected game, based on a result of the determination and the respective positions of the terminal devices 400; and a stage for outputting, from a speaker 29 (229), a voice having a voice pattern associated with a player-selected character, based on an input to the microphone 30 (227), in relation to a player-selected game running in the targeted terminal device 400.

(Configuration of Controller 100)

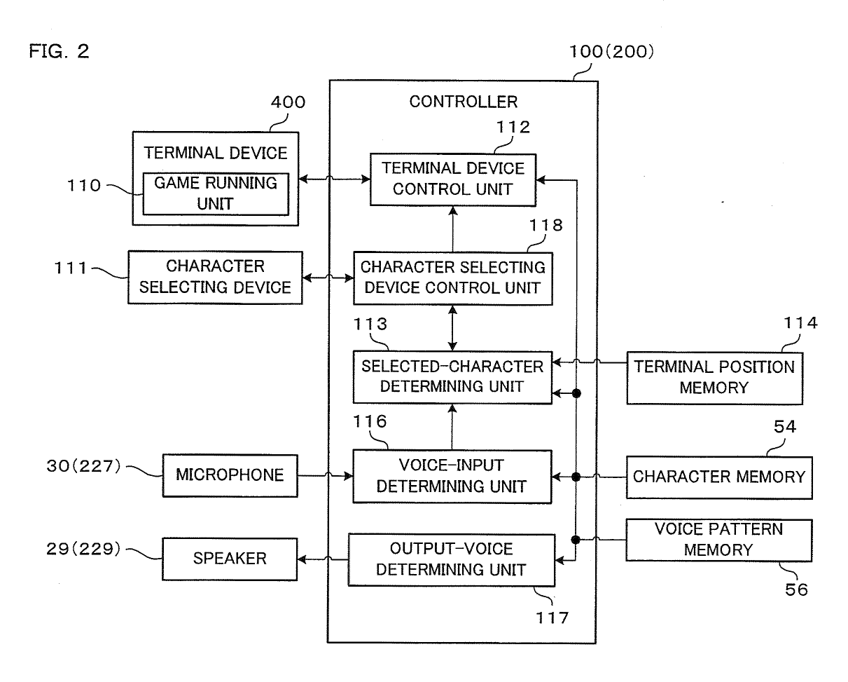

As shown in FIG. 2, a gaming device 10 which executes the above mentioned playing method includes: a character memory 54; a voice pattern memory 56; a character selecting device 111; terminal devices 400; a microphone 30 (227); a speaker 29 (229); a terminal position memory 114; and a controller 100.

Each of the terminal devices 400 includes a game running unit 110 and is capable of accessing a later-mentioned terminal device control unit 112. The game running unit 110 runs a game according to control performed by the terminal device control unit 112.

The character memory 54 stores a plurality of different characters related to a game run by the game running unit 110. The character memory 54 can be accessed through the controller 100.

The voice pattern memory 56 stores voice patterns respectively associated with the characters stored in the character memory 54. The character memory stores a plurality of characters which are different from each other, and as such, there are a plurality of different voice patterns respectively associated with the characters. This voice pattern memory 56 can be accessed through the controller 100.

The character selecting device 111 requests a player to select a character related to a game run by the game running unit 110. The character selecting device 111 is capable of accessing a later-mentioned character selecting device control unit 118.

The microphone 30 (227) receives a voice externally input, and converts the received voice into voice data in the form of an electric signal. The speaker 29 (229) converts the voice data as an electric signal into a voice and then outputs the voice.

The terminal position memory 114 has a function of storing data related to a position of the each terminal device 400. The terminal position memory 114 is connected to a selected-character determining unit 113. The selected-character determining unit 113 has a function of determining if a character is selected and what character is selected in the each terminal device 400, based on an ending status of a game running in the each terminal device 400, a selection made through the character selecting device 111, information stored in the terminal position memory 114, and a result of a determination performed by a voice-input determining unit 116. Note that the selected-character determining unit 113 may perform the above described determination, based on an ending status of a game running in the each terminal device 400, and a selection made through the character selecting device 111. Further, the selected-character determining unit 113 may perform the above described determination, based on an ending status of a game running in the each terminal device 400, a selection made through the character selecting device 111, and information stored in the terminal position memory 114. Further, the selected-character determining unit 113 may perform the above determination, based on a result of a determination performed by the voice-input determining unit 116.

The controller 100 is configured to perform: a first process for determining if any of the characters is selected and which one of the characters is selected in each of the terminal devices 400; a second process for requesting the player to select through the character selecting device 111 a character other than one selected in a terminal device 400 located within a predetermined distance from a targeted terminal device, based on the result of the first process and the respective positions of the terminal devices 400; a third process for outputting, from a speaker 29 (229), a voice having a voice pattern associated with a player-selected character, based on an input to the microphone 30 (227), in relation to a player-selected game running in the targeted terminal device 400. In other words, the controller 100 includes first to third process units.

As shown in FIG. 2, the controller 100 includes: the terminal device control unit 112; the selected-character determining unit 113; the voice-input determining unit 116; an output-voice determining unit 117; and the character selecting device control unit 118.

The terminal device control unit 112 is connected to a terminal device 400. The terminal device control unit 112 has a function of causing the game running unit 110 to run a game, using a selected character stored in the character memory 54, based on the selection made through the character selecting device 111. Further, the terminal device control unit 112 has a function of detecting an ending of a game running in the each terminal device 400 and a game running-status of the each terminal device 400.

The selected-character determining unit 113 determines if any one of the plurality of different characters is selected and which one of the characters is selected in each of the terminal devices 400. The selected-character determining unit 113 receives data indicating a character selected through the character selecting device 111 and data identifying the corresponding terminal device 400. Further, the selected-character determining unit 113 receives data identifying a terminal device 400 and data notifying an end of a game run by the game running unit 110 of the terminal device 400. Based on these sets of data, the selected-character determining unit 113 determines if any one of the plurality of different characters is selected and what character is selected in each of the terminal devices 400.

Based on the positional data of the terminal devices in the terminal position memory 114, the selected-character determining unit 113 specifies a character selected in a terminal device 400 within a predetermined distance from a targeted terminal device 400.

The character selecting device control unit 118 is connected to the character selecting device 111 and the selected-character determining unit 113. The character selecting device control unit 118 has a function of requesting the player to select, through the character selecting device 111, a character from those selectable based on the result of a determination performed by the selected-character determining unit 113. Further, the character selecting device control unit 118 has a function of outputting the player-selected character to the terminal device control unit 112 and the selected-character determining unit 113.

The voice-input determining unit 116 is connected to the microphone 30 (227), a character memory 54, and the selected-character determining unit 113. The voice-input determining unit 116 has a function of determining if voice data input to the microphone 30 (227) corresponds to a voice of any of the characters and if the voice data corresponds to a game being run by the game running unit 110, based on the character data in the character memory 54, the voice pattern associated with the character, and the game running-status.

The output-voice determining unit 117 is connected to the voice-input determining unit 116, the terminal device control unit 112, the character memory 54, the voice pattern memory 56, and the speaker 29 (229). The output-voice determining unit 117 has a function of determining a reply to the input voice data, based on the result of a determination performed by the voice-input determining unit 116, the character data in the character memory 54, the voice pattern data associated with the character data, and a game running-status. The output-voice determining unit 117 further has a function of outputting the reply thus determined, in the form of voice from the speaker 29 (229).

Meanwhile, each block of the game controller 100 may be structured in hardware or software manner, as required.

(Operation of Game Controller 100)

The following describes an operation of the controller 100 in the above structure. First, a character is selected through the character selecting device 111. Then, the selected-character determining unit 113 receives data identifying a targeted terminal device 400 and data indicating the player-selected character. Further, when the game ends in the terminal device 400, the selected-character determining unit 113 receives the data identifying the terminal device 400 and data indicating an end of the game run by the game running unit 110. Then, the selected-character determining unit 113 determines if any one of the plurality of different characters is selected and what character is selected in each of the terminal devices 400. Through these processes, the controller 100 performs the first process for determining if any one of the plurality of different characters is running and which one of the characters is running in each of the terminal devices 400.

Based on the result of the first process and positional data of the terminal devices in the terminal position memory 114, the selected-character determining unit 113 specifies a character selected in a terminal device 400 within a predetermined distance from a targeted terminal device. The character selecting device control unit 118 requests the player to make a selection through the character selecting device 111, using data indicating characters specified by the selected-character determining unit 113. Through these processes, the controller 100 performs the second process for requesting the player to select through the character selecting device 111 a character other than one selected in a terminal device 400 located within a predetermined distance from a targeted terminal device 400.

The character selecting device control unit 118 outputs to the terminal device control unit 112 data indicating a character selected through the character selecting device 111. The terminal device control unit 112 reads out from the character memory 54 character data related to the player-selected character which is input from the character selecting device control unit 118. Further, the terminal device controlling unit 112 reads out, from the voice pattern memory 56, voice pattern data associated with the player-selected character. The terminal device control unit 112 outputs the read out character data and voice pattern data to the targeted terminal device 400. During the game, the targeted terminal device 400 having received the character data and the voice pattern data outputs a voice from the speaker 229 based on the voice pattern.

The voice-input determining unit 116 determines if voice data input to the microphone 30 (227) corresponds to a voice of any of the characters and if the voice data corresponds to a game being run by the game running unit 110. Then, the voice-input determining unit 116 outputs the result to the output-voice determining unit 117. The output-voice determining unit 117 then determines a reply to the voice input, and outputs the reply from the speaker 29 (229) in a voice having the voice pattern associated with the selected character. In this way, the controller 100 performs based on an input to the microphone 30 (227), the third process which uses a voice pattern corresponding to a selected character to output from the speaker 29 (229) a voice related to the game to be run in the targeted terminal device 400.

As is obvious from the above operation, the gaming device 10 realizes a playing method including: a stage for determining if any of the characters is selected and which one of the characters is selected in each of the terminal devices 400; a stage for requesting the player to select through the character selecting device 111 a character other than one selected in a terminal device 400 located within a predetermined distance from the targeted terminal device, based on the result of the determination and the respective positions of the terminal devices 400; and a stage for outputting, from a speaker 29 (229), a voice having a voice pattern associated with a player-selected character, based on an input to the microphone 30 (227), in relation to a player-selected game running in the targeted terminal device 400.

According to the above playing method, the player is requested to select a character other than one selected in a terminal device within a predetermined distance from a terminal device to run a player-selected game, at the time of selecting a character from the plurality of characters. It is therefore possible to avoid outputting, from the speakers of these terminal devices, a game-related voice having an identical voice pattern associated with a single character. Thus, it is possible to provide a suitable gaming environment whereby players are not confused by outputting at the same time game-related voices having an identical voice pattern. Further, voice patterns are respectively associated with characters. This enables the player to easily make his/her selection of a voice pattern. Further, the player is requested to select a character other than one selected in a terminal device within a predetermined distance from a terminal device to run a player-selected game, at the time of selecting a character from the plurality of characters. It is therefore possible to avoid outputting, from speakers located within a predetermined distance from each other, a game-related voice having an identical voice pattern associated with a single character. Thus, it is possible to provide a suitable gaming environment whereby players are not confused by outputting within a predetermined distance game-related voices having an identical voice pattern at the same time. Although speakers located within a predetermined distance from each other are prohibited from outputting a game-related voice having an identical voice pattern associated with a single character at the same time, a game-related voice having the same voice pattern can be output at the same time from a speaker outside of the predetermined distance. The player therefore is provided with a larger selection of selectable characters, and more enjoyable gaming environment.

(Gaming Device 10 and Flow of Playing Method)

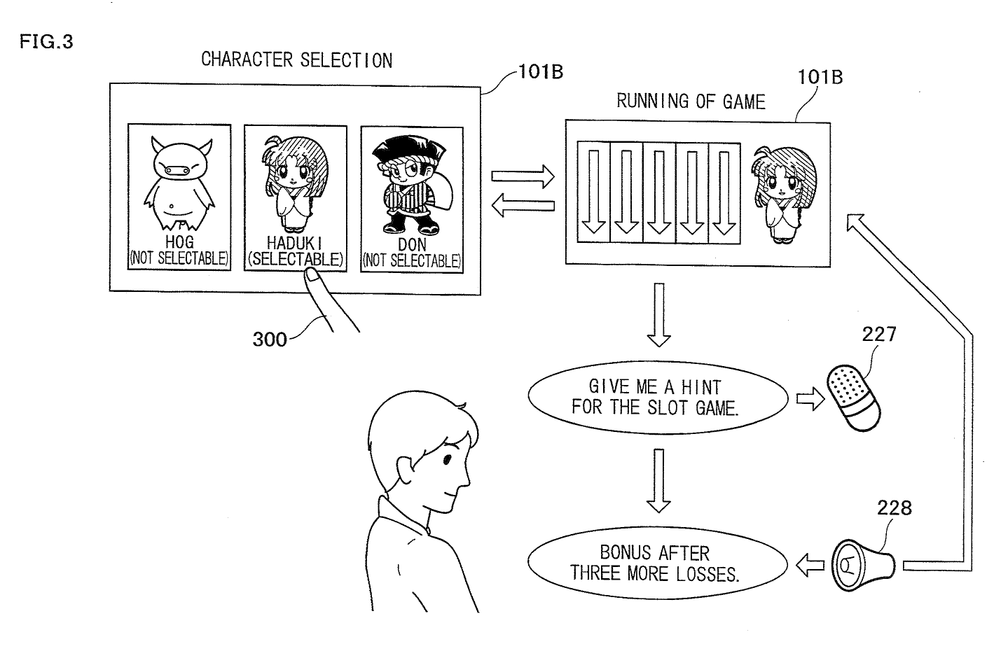

The following specifically describes an exemplary flow of the above mentioned gaming device 10 and the playing method thereof, with reference to FIG. 3.

As shown in FIG. 1, the each terminal device 400 is provided with a display 101B. The display 101B displays characters to be selected by the player, as shown in FIG. 3. In short, the display 101B constitutes a part of the character selecting device 111. Further, the display 101B displays characters the player can select. For example, as shown in FIG. 3, the display 111B indicates that “Haduki” is selectable, but not “Hog” or “Don”. The display 101B receives a selectable character signal from the gaming machine main body 1. The selectable character signal is a signal indicating a selectable character. The display 101B then displays a selectable character based on the selectable character signal received.

On the front surface of the display 101B provided is a later-mentioned touch panel 226. As shown in FIG. 3, pressing the touch panel 226 with a finger F allows the player to select a character which is indicated as selectable and which is displayed in a portion of the display 101B corresponding to the portion pressed by the finger F. That is, the touch panel 226 constitutes a part of the character selecting device 111. Through this, the display 101B and the touch panel 226 serving as the character selecting device 111 allow the player to select a character.

When the player selects a character, the terminal device 400 runs the player-selected game. The display 101B then displays an effect related to the game based on the a game running-status, as shown in FIG. 3.

When the player inputs a voice related to the game to the microphone 227 while the game is running, a game-related voice according to the input is output from the speaker 229 in a voice pattern associated with the selected character. Specifically, when a voice input to the microphone 227 is a phrase “Give me a hint for the slot game”, then a phrase “Bonus after three more losses” is output from the speaker 229 in a voice having the voice pattern associated with “Haduki” which is the selected character.

Note that the present embodiment deals with a case where the display 101B and touch panel 226 serve as the character selecting device 111. However, the present invention is not limited to this, provided that a player is able to select a character. For example, the selection can be made by means of an input using a switch, or a voice input.

(Relation Between Selected Character and Selectable Character)

The following describes a relation between a selected character and a selectable character. In Embodiment 1, the plurality of different characters are the following three characters: “Hog”, “Haduki”, and “Don”. Further, the plurality of terminal devices 400 are provided. Note that the targeted terminal device 400 for running a player-selected game outputs from its speaker 229 a game-related voice having the voice pattern associated with the player-selected character.

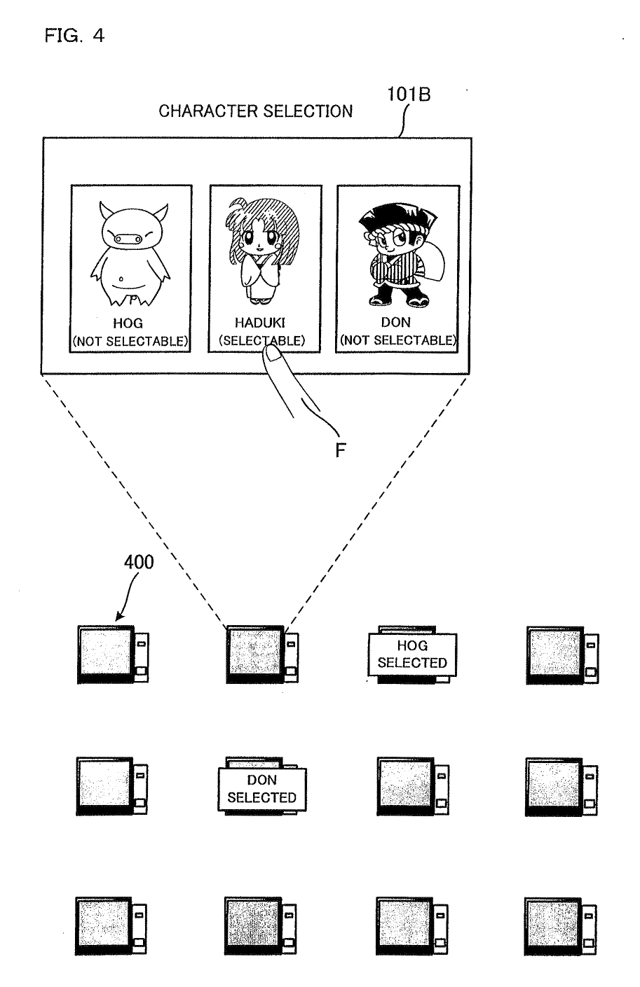

In the gaming device 10 of the present embodiment shown in FIG. 4, “Hog” is selected in one terminal device 400, and “Don” in another terminal device 400. In this case, “Hog” and “Don” are not selectable while “Haduki” is selectable, in the targeted terminal device 400 for accepting an entry of a player-selected character and running a player selected game. That is, the player is not able to select a character selected in a terminal device 400, but is able to select a character which is not selected in any of the other terminal devices 400. In this manner, the gaming device 10 requests the player to select a character other than one selected in the terminal device 400. Note that the targeted terminal device 400 for running a player-selected game outputs from its speaker 229 a game-related voice having the voice pattern associated with the player-selected character.

Thus, the player is requested to select a character other than one selected in a terminal device within a predetermined distance from a terminal device to run a player-selected game, at the time of selecting a character from the plurality of characters. It is therefore possible to avoid outputting, from the speakers of these terminal devices, a game-related voice having an identical voice pattern associated with a single character. Thus, it is possible to provide a suitable gaming environment whereby players are not confused by outputting at the same time game-related voices having an identical voice pattern. Further, voice patterns are respectively associated with characters. This enables the player to easily make his/her selection of a voice pattern.

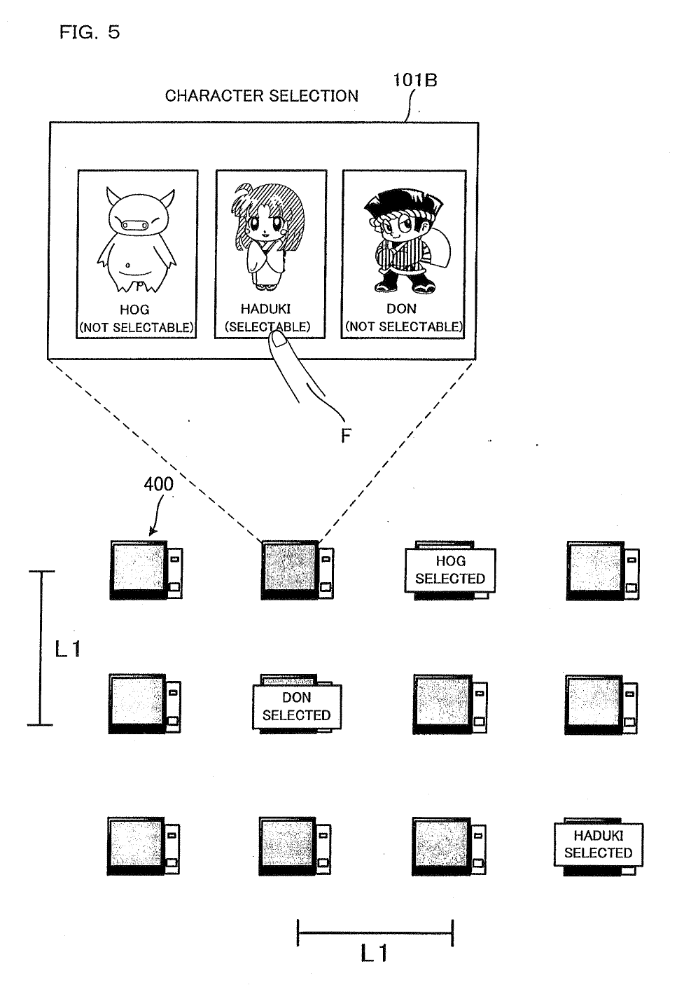

Further, in the gaming device 10 of the present embodiment shown in FIG. 5, “Hog” and “Don” are selected in terminal devices 400 located within a distance L1 from the targeted terminal device 400. On the other hand, a “Haduki” is selected in a terminal device 400 located apart from the targeted terminal device 400 by more than the distance L1. In this case, “Hog” and “Don” are not selectable while “Haduki” is selectable, in the targeted terminal device 400 for accepting an entry of a player-selected character and running a player selected game. In other words, the player is not able to select a character selected in a terminal device 400 located within a predetermined distance from the targeted terminal device 400, but is able to select a character which is not selected in the terminal device 400 located within the predetermined distance. As described, the gaming device 10 only allows the player to select a character other than one selected in a terminal device 400 located within the predetermined distance from the targeted terminal device 400. Note that the targeted terminal device 400 for running a player-selected game outputs from its speaker 229 a game-related voice having the voice pattern associated with the player-selected character.

Thus, the player is requested to select a character other than one selected in a terminal device within a predetermined distance from a terminal device to run a player-selected game, at the time of selecting a character from the plurality of characters. It is therefore possible to avoid outputting, from speakers located within a predetermined distance from each other, a game-related voice having an identical voice pattern associated with a single character. Thus, it is possible to provide a suitable gaming environment whereby players are not confused by outputting within a predetermined distance game-related voices having an identical voice pattern at the same time. Further, voice patterns are respectively associated with characters. This enables the player to easily make his/her selection of a voice pattern. Although speakers located within a predetermined distance from each other are prohibited from outputting a game-related voice having an identical voice pattern associated with a single character at the same time, a game-related voice having the same voice pattern can be output at the same time from a speaker outside of the predetermined distance. The player therefore is provided with a larger selection of selectable characters, and more enjoyable gaming environment.

(Mechanical Configuration: Gaming Machine Main Body 1)

The following describes an example of a mechanical and electrical configuration of the above mentioned gaming device 10.

As shown in FIG. 1, the gaming device 10 is provided in a game arcade. The gaming device 10 runs a unit game by using a game medium which is a game value. The game medium is a coin, bill or electronic negotiable information corresponding to them. Meanwhile, in the present invention, the game medium is not particularly limited. For example, a medal, token, electronic money, ticket and the like can be used. The ticket is not particularly limited and may be a ticket or the like with a barcode which will be described later.

As shown in FIG. 1, the gaming device 10 has a gaming machine main body 1 and a gaming machine terminal 2. The gaming machine main body 1 includes: a controller 100 having devices such as a calculation device, a memory device or the like; and a display 101A such as a liquid crystal display which is controlled by the controller 100. The display 101A has a large size so that many players surrounding the display 101A from a distance are able to see view the display 101A. The display 101A displays various information and effect images or the like related to the games. The gaming machine main body 1 has a not-shown speaker 29 and a microphone 30. The speaker 29 outputs a voice related to the games. To the microphone 30, a voice is input.

(Mechanical Configuration: Gaming Machine Terminal 2)

A gaming machine terminal 2 is disposed in front of the display 101A. The gaming machine terminal 2 has a cabinet 3, a plurality of terminal devices 400 provided to the cabinet 3 and a plurality of chairs 4 disposed nearby the cabinet 3. The cabinet 3 is formed in a fan-like shape with the display 101A as its center point. The terminal devices 400 are disposed at an equal interval on the cabinet 3. In addition, coin trays 416 are disposed at a side of the cabinet 3.

The terminal device 400 has a liquid crystal display device that forms the display 101B, an operating panel 415, the coin tray 416, a touch panel 226, and a microphone 227. The operating panel 415 has a coin receiving slot and a bill validator. A control panel 220 is provided with a variety of buttons. These buttons allow the player to input instructions related to a game played by the player. Through the coin receiving slot, a coin is received in the cabinet 3. The display 101B displays various information and effect images or the like related to the games.

The operating panel 415 is provided with a change button, a cash out button. The change button is a button to be used when a player asks a staff person in the game arcade for exchange of money. The cash out button is a button for inputting an instruction to pay out the coins corresponding to the total credit-value into the coin tray 416.

The bill validator validates whether bill is normal or not and receives the normal bill into the terminal device 400. In addition, the bill validator can read a ticket having a barcode attached thereto. When the bill validator reads the ticket, it outputs a reading signal relating to the content read.

Further, the operating panel 415 is provided with a ticket printer, a card reader, a data displayer and a keypad. The ticket printer prints, on to a ticket, a barcode having encoded data containing credit-value, date and time, identification number of the gaming device 10 or the like, thereby outputting the ticket having the barcode attached thereto. A player can play a game in another gaming device 10 with the ticket having the barcode or exchange the ticket having the barcode with bill at a change booth of the game arcade.

The card reader reads and writes data from and into a smart card. The smart card is a card carried by a player, and stores therein data for identifying the player, data relating to a history of games played by the player, or the like.

The data displayer includes a fluorescent display or the like, and displays the data read by the card reader and the data input by the player through the keypad. The keypad inputs instructions or data relating to issuing of a ticket.

A belly glass is provided around the operating panel 415 or on a side of the gaming machine terminal 2. On the belly glass, a character of the gaming device 10 or the like is drawn. In addition, the terminal device 400 is adapted to display an image representative of an effect image, introduction of game contents and explanation of game rules. Furthermore, the cabinet 3 is provided with a speaker 229 for a voice output.

A translucent touch panel 226 is provided in front of the display 101B. The touch panel 226 is provided with signal lines arranged in the horizontal direction (X direction) and the vertical direction (Y direction), and switch units arranged in a matrix manner. When a finger F or the like presses the front surface of the touch panel 226 as shown in FIG. 3 to FIG. 5, the touch panel 226 outputs an X-Y coordinate of a switch unit turned to the on-state by the pressing force applied, so as to enable identification of a pressed position.

The microphone 227 receives a voice input, and converts the voice into an electric signal.

(Electric Configuration: Gaming Machine Main Body 1)

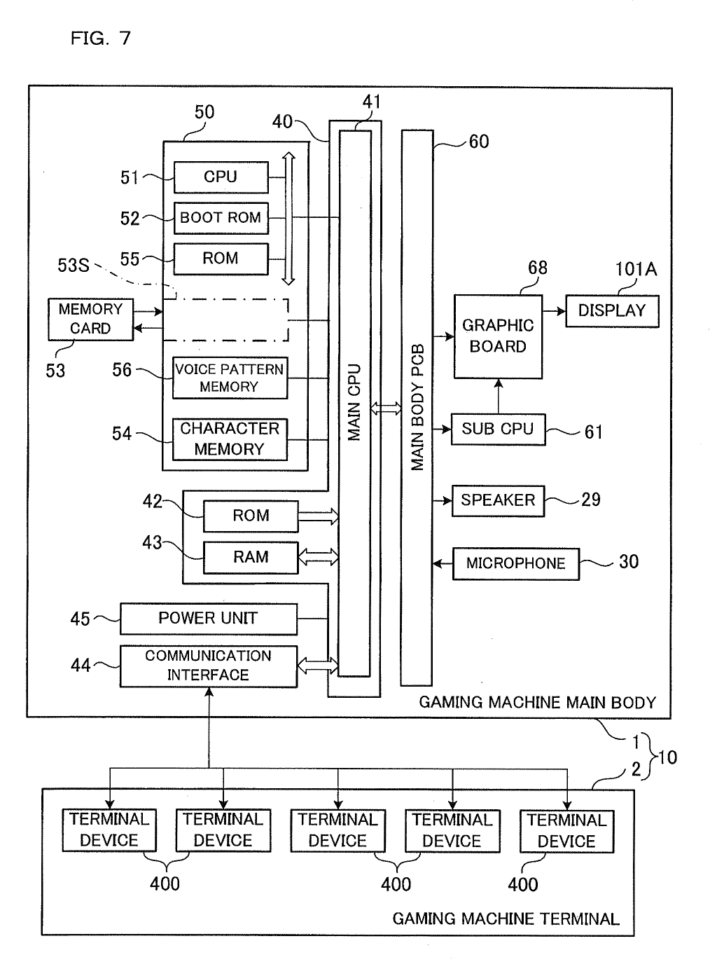

A control unit in FIG. 7 is mounted in the controller 100 of the gaming machine main body 1. The control unit includes a motherboard 40, a main body PCB (Printed Circuit Board) 60, a gaming board 50, a sub CPU 61, various switches, microphone 30, and a speaker 29.

The gaming board 50 is provided with a CPU (Central Processing Unit) 51, an ROM 55, a boot ROM 52, a card slot 53S corresponding to a memory card 53, a character memory 54, and a voice pattern memory 56 which are connected through an internal bus.

The memory card 53 stores therein a plurality of game programs and game system programs. Further, the memory card 53 stores therein various types of data for use in the game programs and the game system programs. These sets of data are transferred to the RAM 43 of the motherboard 40, at the time of running a game programs.

Further, the card slot 53S is configured so as to enable insertion and detaching of the memory card 53. This card slot 53S is connected to the motherboard 40 via IDE bus. Thus, the type and content of a game run by the gaming device 10 can be modified by detaching the memory card 53 from the card slot 53S, write into a different game and a different game system program into the memory card 53, and inserting the memory card 53 into the card slot 53S.

Each of the game programs includes a program related to the progress of the game, a program for transiting to a bonus game, and image data and voice data output during a game.

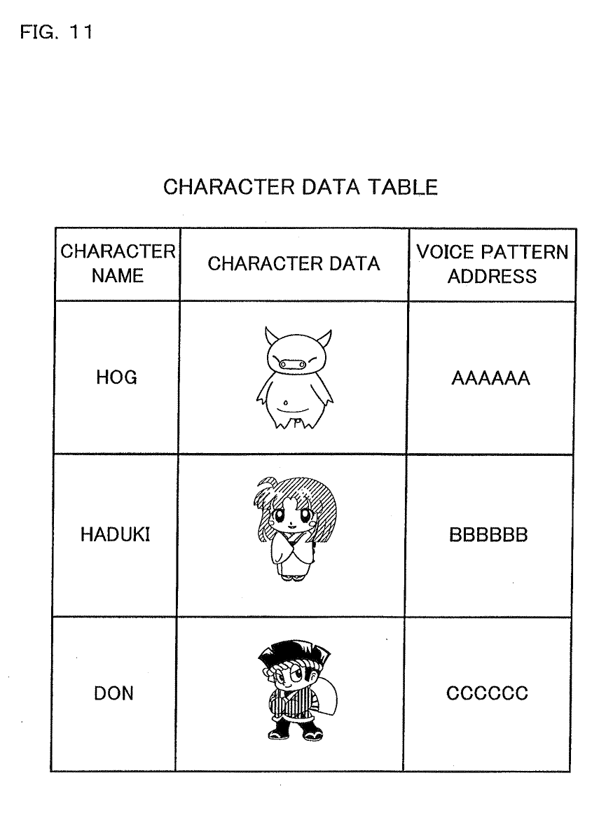

The character memory 54 stores therein a plurality of different sets of character data. The character data sets respectively correspond to later-mentioned sets of voice pattern data. The character data is data for use in effects at the time of running a game, and represents an image of a character or the like, as shown in FIG. 11. The character data is transferred to the RAM 43 of the motherboard 40, at the time of running a game program.

The voice pattern memory 56 stores therein a plurality of different sets of voice pattern data. The voice pattern data sets respectively correspond to the sets of character data. The voice pattern data contains information of a characteristic pattern extracted from a voice. It is known that every person has unique voice pattern, and a voice pattern of one person differs from those of others. Thus, when a voice is output in a different voice pattern from a speaker, the player who hears the voice is able to recognize the voice as a voice from a different person. It is therefore possible to prevent the player from being confused by the voice. The voice pattern data is transferred to the RAM 43 of the motherboard 40, at the time of running a game system programs.

Further, sets of character data and voice pattern data respectively correspond to each other. Therefore, specifying one of the voice pattern data and the character data allows specifying of the other.

The CPU 51, the ROM 55 and the boot ROM 52, which are connected to each other through the internal bus, are connected to the motherboard 40 through the PCI bus. The PCI bus performs a signal transfer between the motherboard 40 and the gaming board 50 and supplies power from the motherboard 40 to the gaming board 50. The ROM 55 stores nation identification information and an authentication program. The boot ROM 52 stores a preliminary authentication program and a program (boot code) enabling the CPU 51 to run the preliminary authentication program.

The authentication program is a program (falsification check program) for authenticating the game program and the game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication to be authenticated is not falsified, i.e., for authenticating the authentication program.

The motherboard 40 is provided with a main CPU 41 (controller), a ROM (Read Only Memory) 42 and a RAM (Random Access Memory) 43. The main CPU 41 serves as a controller and has a function of controlling the entire gaming device 10. In particular, the main CPU 41 performs control of, for example, an operation for determining what character is selected in the each terminal device 400.

The main CPU 41 serves as the controller 100 configured to perform: a process for determining if a character is selected and which character is selected in terminal devices 400; a process for requesting a player to select through a character selecting device 111 a character other than one selected in a terminal device 400 located within a predetermined distance from a targeted terminal device, based on a result of the determination and the respective positions of the terminal devices 400; and a process for outputting, from a speaker 29 (229), a voice having a voice pattern associated with a player-selected character, based on an input to the microphone 30 (227), in relation to a player-selected game running in the targeted terminal device 400.

The ROM 42 stores a program such as BIOS (Basic Input/Output System) run by the main CPU 41, and data that is permanently used. When the BIOS is run by the main CPU 41, each of peripheral devices is initialized and the game program and the game system program stored in the memory card 53 are read out through the gaming board 50.

The RAM 43 stores the data or program which is used when the main CPU 41 carries out a process.

The motherboard 40 is connected to a communication interface 44. The communication interface 44 is provided to communicate with the terminal devices 400, a host computer or the like through a communication line, which are mounted in the game arcade. Further, the motherboard 40 is connected to a power unit 45. When power is supplied to the motherboard 40 from the power unit 45, the main CPU 41 of the motherboard 40 is operated and the power is supplied to the gaming board 50 through the PCI bus, so that the CPU 51 is also operated.

The main body PCB 60 is connected to the motherboard 40 via a signal bus. To the main body PCB 60, a graphic board and a speaker 29 are connected.

The graphic board 68 controls an image display performed by the display 101A, based on a control signal output from the main CPU 41. In addition, the graphic board 68 is provided with a VDP for generating image data on the basis of the control signal output from the main CPU 41, a video RAM for temporarily storing the image data generated by the VDP, or the like.

(Electrical Configuration: Gaming Machine Terminal 2)

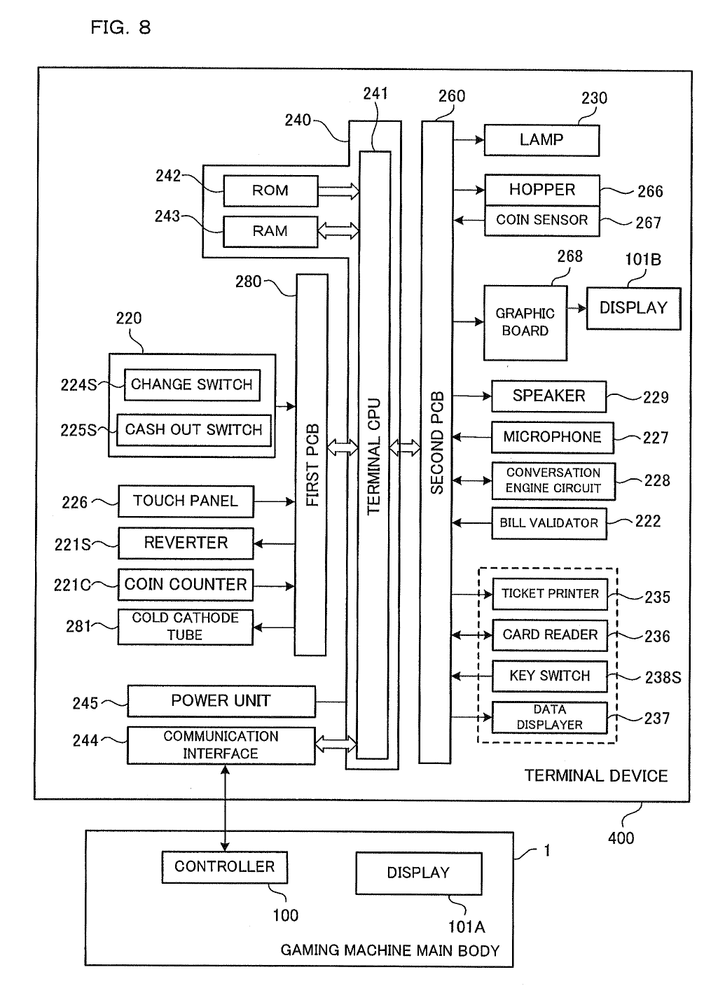

Each terminal device 400 provided to the gaming machine terminal 2 has a control unit shown in FIG. 8. The control unit has a motherboard 240, a first PCB 280, a second PCB 260, various switches and a speaker 229. The motherboard 240 has a terminal CPU 241, a ROM 242 and a RAM 243. The terminal CPU 241 serves as a controller and controls the overall terminal device 400.

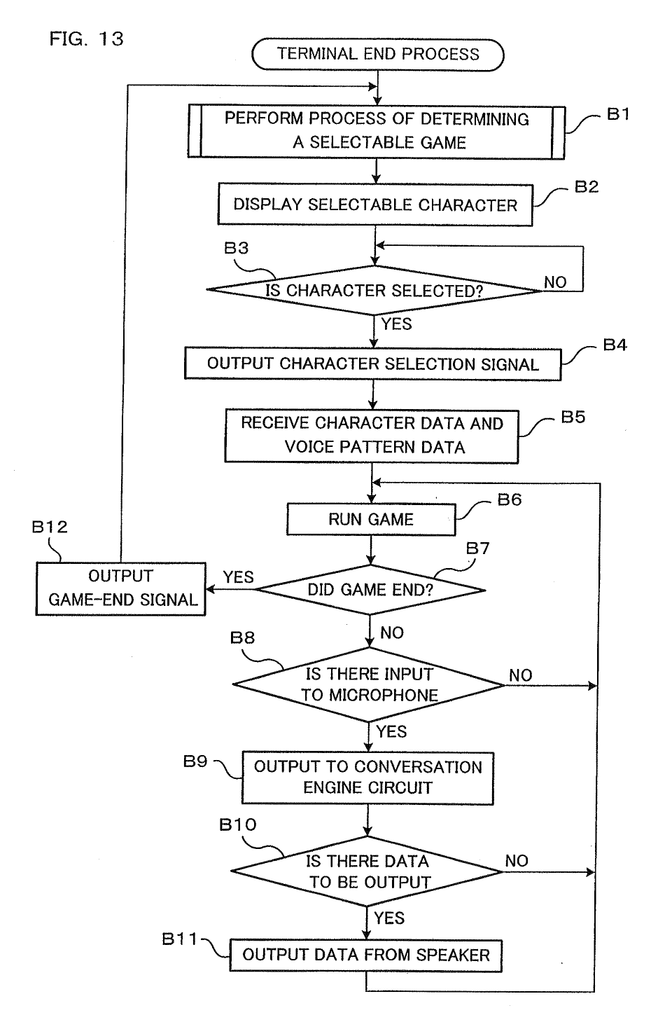

The ROM 242 stores a program such as BIOS (Basic Input/Output System) run by the terminal CPU 241, a process routine of the terminal shown in FIG. 13 and data that is permanently used. When the BIOS is run by the terminal CPU 241, each of peripheral devices is initialized. The RAM 243 stores data that is used when the terminal CPU 241 performs a process.

The terminal CPU 241 is connected to a communication interface 244. The communication interface 44 is provided to communicate with the gaming machine main body 1 through a communication line. Further, the motherboard 240 is connected to a power unit 245. When power is supplied to the motherboard 240 from the power unit 245, the terminal CPU 241 of the motherboard 240 is operated.

The motherboard 240 is connected with the first PCB 280 and the second PCB 260 through a signal bus. The first PCB 280 is connected to a device or apparatus for generating an input signal to be input to the terminal CPU 241, and a device or apparatus controlled by a control signal output from the terminal CPU 241. The terminal CPU 241 runs the game program and the game system program stored in the RAM 243 based on the input signal input to the terminal CPU 241, to carry out an arithmetic process, thereby storing a result thereof in the 2RAM 43 or transmitting a control signal to each device or apparatus.

The second PCB 260 is connected with a lamp 230, a hopper 266, a coin sensor 267, a graphic board 268, the speaker 229, a bill validator 222, a ticket printer 235, a card reader 236, a key switch 238S, a data displayer 237, a microphone 227, and a conversation engine circuit 228.

The lamp 230 is turned on/off on the basis of the control signal output from the terminal CPU 241. The hopper 266 is mounted in the cabinet 3 and pays out a predetermined number of coins to the coin tray 416, based on the control signal output from the terminal CPU 241. The coin sensor 267 detects that the predetermined number of coins are paid out and outputs an input signal to the terminal CPU 241.

The graphic board 268 controls an image display in the display 101B, based on the control signal output from the terminal CPU 241. In addition, the graphic board 268 is provided with a VDP for generating image data on the basis of the control signal output from the terminal CPU 241, a video RAM for temporarily storing the image data generated by the VDP, and the like.

The bill validator 222 reads an image of the bill and accommodates the normal bill in the cabinet 3. In addition, when accommodating the normal bill, the bill validator 222 outputs an input signal to the terminal CPU 241, based on an amount of the bill. The terminal CPU 241 stores a credit-value, which corresponds to the amount of the bill transmitted by the input signal, in the RAM 43, and transmits the credit-value to the gaming machine main body 1 through the communication interface 244.

The ticket printer 235 prints, on to a ticket, a barcode containing encoded data such as credit-value stored in the RAM 43, date and time, identification number of the gaming device 10 or the like, based on the control signal output from the terminal CPU 241, thereby outputting the ticket having the barcode.

The card reader 236 reads the data from the smart card to transmit it to the terminal CPU 241, and writes the data into the smart card, based on the control signal output from the terminal CPU 241. The key switch 238S is mounted to the keypad, and outputs an input signal to the terminal CPU 241 when the player manipulates the keypad. The data displayer 237 displays, based on the control signal output from the terminal CPU 241, the data read by the card reader 236 or the data input by the player through the key switch 238S. In the mean time, the data is transmitted to the gaming machine main body 1 through the communication interface 244.

The first PCB 280 is connected with a control panel 220, a reverter 221S, a coin counter 221C and a cold cathode tube 281. The control panel 220 is provided with a change switch 224S corresponding to the change button and a cash out switch 225S corresponding to the cash out button. Each of the switches 224S and 225S outputs an input signal to the terminal CPU 241 when each of the corresponding buttons is pushed by a player.

The coin counter 221C validates whether a coin, which is inserted by the player, is normal or not. A coin except the normal coin is discharged from the coin tray 416. In addition, the coin counter 221C outputs an input signal to the terminal CPU 241 upon detection of a normal coin.

The coin counter 221C is operated on the basis of the control signal output from the terminal CPU 241 and distributes a coin, which is recognized as a normal coin by the coin counter 221C, to a cash box or hopper 266 mounted in the gaming device 10. In other words, when the hopper 266 is fully filled with the coins, the normal coin is distributed into the cash box by the reverter 221S. In the mean time, when the hopper 266 is not fully filled with the coins, the normal coin is distributed into the hopper 266. The cold cathode tube 281 functions as a backlight mounted to rear sides of the display 101B and is turned on, based on the control signal output from the terminal CPU 241.

The microphone 227 receives a voice input, and converts the voice input into a voice signal. The conversation engine circuit 228 analyzes the voice signal from the microphone 227, based on a game running-status, a voice related to a game stored in RAM 243, and the game data. Further, the conversation engine circuit 228 determines a voice to be given in reply to the analyzed a voice signal, based on a game running-status, a voice related to a game stored in RAM 243, the voice pattern data and the character data.

(Terminal Device Position Table)

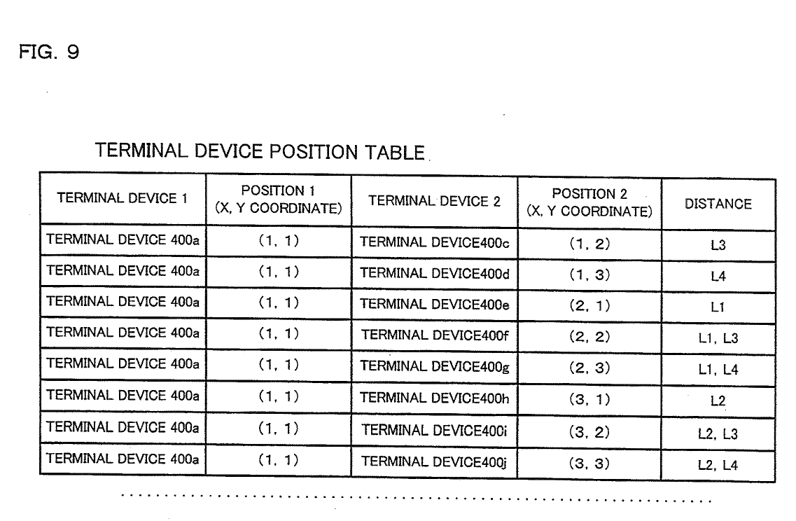

The following describes a terminal device position table shown in FIG. 9. Data of this table is stored in the RAM 43 of the gaming machine main body 1. The table at least includes a list of terminal devices 1, a list of positions 1, a list of terminal devices 2, a list of positions 2, and a list of distances. Each data item in the list of terminal device 1 and the lists of terminal devices 2 is a data item indicating a terminal device. Each data item in the list of positions 1 is a data item indicating a position coordinate of a terminal device indicated by the data item in the list of the terminal devices 1. Each data item in the list of positions 2 is a data item indicating a position coordinate of a terminal device indicated by the data item in the list of the terminal devices 2. Each data item in the list of the distances is a data item indicating a distance between position coordinates indicated by a data item in the list of positions 1 and a corresponding data item in the list of positions 2.

More specifically describing the terminal device position table shown in FIG. 9, the position coordinate (x,y) of the terminal device 400a is (1, 1), the position coordinate of the terminal device 400c is (1, 2), and the distance between the terminal devices 400a and 400c is L3. The position coordinate of the terminal device 400d is (1, 3), and the distance between terminal devices 400a and 400d is L4. The position coordinate of the terminal device 400e is (2, 1), and the distance between terminal devices 400a and 400e is L1. The position coordinate of the terminal device 400f is (2, 2), and the distance between terminal devices 400a and 400f is L1 in the horizontal direction and is L3 in the longitudinal direction. The position coordinate of the terminal device 400g is (2, 3), and the distance between terminal devices 400a and 400g is L1 in the horizontal direction and is L4 in the longitudinal direction. The position coordinate of the terminal device 400h is (3, 1), and the distance between terminal devices 400a and 400h is L2 in the horizontal direction. The position coordinate of the terminal device 400i is (3, 2), and the distance between terminal devices 400a and 400i is L2 in the horizontal direction and is L3 in the longitudinal direction. The position coordinate of the terminal device 400j is (3, 3), and the distance between terminal devices 400a and 400j is L2 in the horizontal direction and is L4 in the longitudinal direction.

Note that the terminal device position table serving as a terminal device position memory is not particularly limited to the one described above, provided that the table is able to store the positions of the terminal devices 400.

(Terminal Device Administration Table)

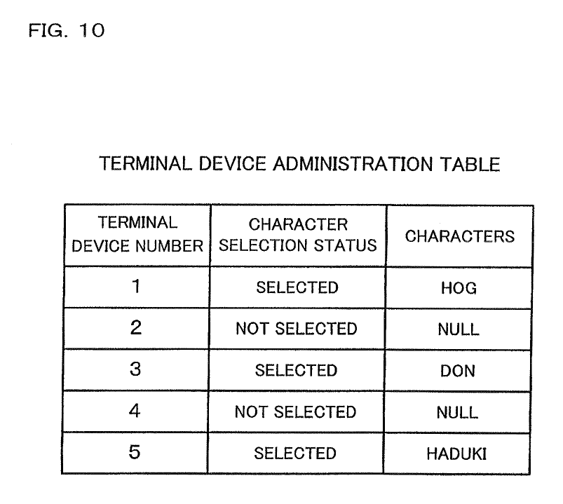

The following describes a terminal device administration table shown in FIG. 10. Data of this table is stored in the RAM 43 of the gaming machine main body 1. This table at least includes a list of terminal numbers, a list of character selection status, and a list of selected characters. The list of terminal device numbers is a list of data indicating the terminal device numbers. The list of character selection statuses is a list of data indicating if a character is selected in the terminal device 400. The list of selected characters is a list of data items each indicating a character selected in a terminal device 400.

More specifically, the terminal device administration table shown in FIG. 10 indicates the following. In a terminal device 400 whose terminal device number is “1”, the table indicates that a character is “Selected”, and that the character selected is “Hog”. In a terminal device 400 whose terminal device number is “2”, the table indicates that a character is “Not Selected”. In a terminal device 400 whose terminal device number is “3”, the table indicates that a character is “Selected”, and that the character selected is “Hog”. In a terminal device 400 whose terminal device number is “4”, the table indicates that a character is “Not Selected”. In a terminal device 400 whose terminal device number is “5”, the table indicates that a character is “Selected”, and that the character selected is “Haduki”.

The terminal device administration table is not particularly limited to the one described above, provided that the table is able to record information indicating if a character is selected in each of the terminal devices 400.

(Character Data Table)

The following describes a character data table shown in FIG. 11. Data of this table is stored in the character memory 54 of the gaming machine main body 1, and is transferred to the RAM 43 of the motherboard 40, at a time of running a game system program. This table at least includes a list of character names, a list of character data, and a list of voice pattern address data. The list of character names is a list of data indicating the names of characters. The list of character data is a list of character data indicating characters used in effects for the games. The list of voice pattern address data is a list of data indicating addresses of voice pattern data associated with the character data. In other words, the character data table stores a plurality of different characters along with the associated voice patterns, so as to associate the sets of the character data with the sets of the voice pattern data, respectively.

More specifically, the character data table shown in FIG. 11 stores data (image data or the like) of a character by the name of “Hog” for example, and indicates that the address of the corresponding voice pattern data is “AAAAAA”. In the voice pattern address “AAAAAA” stored is, for example, voice data of “Hog” saying “Bonus after N times more losses”, where N indicates that voice data indicating a given number is inserted therein. Further, the character data table stores data (image data or the like) of a character by the name of “Haduki”, and indicates that the address of the associated voice pattern data is “BBBBBB”. Further, the character data table stores data (image data or the like) of a character by the name of “Don”, and indicates that the address of the associated voice pattern data is “CCCCCC”.

Note that the character data table is not particularly limited to the above, provided that the table is able to store a plurality of characters and associated voice patterns, and is able to associating the characters and the voice patterns on one-to-one basis.

(Process Performed in Gaming Machine Main Body 1)

The following describes a process performed in the gaming machine main body 1. A game starts when the main CPU 41 of the game controller 100 reads out and runs a game program.

(Process Performed in Gaming Machine Main Body 1: Process Routine at Main Body End)

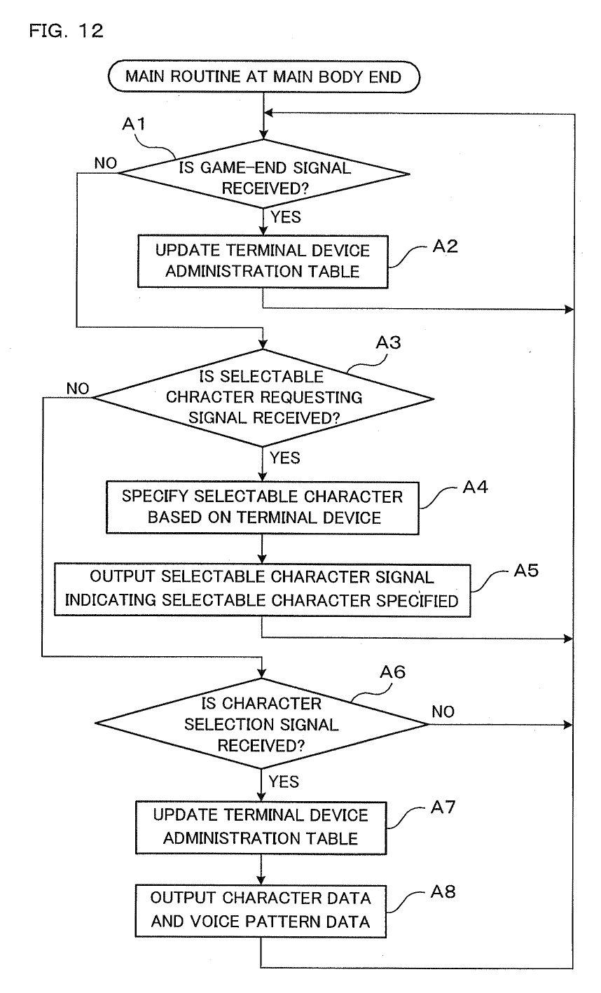

As shown in FIG. 12, in a process routine performed at the main body end, the main CPU 41 determines if a game-end signal is received from a terminal device 400 (A1). If the main CPU 41 determines that the game-end signal from the terminal device 400 is received (A1: YES), the terminal device administration table is updated (A2). Specifically, the table is updated so as to indicate “Not Selected” in the corresponding character selection status of the terminal device number indicated by the game-end signal received. The process then returns to A1.

In A1, if the main CPU 41 determines that no game-end signal is received (A1: NO), the main CPU 41 determines if a selectable character requesting signal is received from a targeted terminal device 400 (A3). If the main CPU 41 determines that a selectable character requesting signal is received (A3: YES), the CPU 41 specifies a selectable character based on the terminal device administration table and terminal device position table (A4). Specifically, based on the terminal device position table, the main CPU 41 specifies positions of a terminal device 400 located within a predetermined distance from the targeted terminal device 400 having output the selectable character requesting signal. Then, the main CPU 41 specifies a character other than one selected in a terminal device thus specified, based on the terminal device administration table. The specified character is a selectable character.

Thus, it is possible to determine if any one of the plurality of different characters is selected and which one of the characters is selected in each of the terminal devices 400.

It is possible to specify a selectable character only based on the terminal device administration table, without referring to the terminal device position table. However, the terminal device position table is preferably used for the purpose of providing a wider selection of selectable characters to the player. Further, the selected-character determining unit 113 determines a selectable character every time a selectable character requesting signal is received. However, this process of determining the selectable character can always be performed by the selected-character determining unit 113.

Next in A4, there is output a selectable character signal indicating the selectable character specified to the targeted terminal device 400 (A5), and the process then returns to A1.

Through these processes, it is possible to request the player to select through the character selecting device 111 a character other than one selected in a terminal device 400 located within a predetermined distance from a targeted terminal device 400.

On the other hand, if the main CPU 41 determines that no selectable character requesting signal is received in A3 (A3: NO), the main CPU 41 determines if a character selecting signal is received from the targeted terminal device 400 (A6). If the main CPU 41 determines that no character selection signal is received (A6: NO), the process returns to A1. On the other hand, if the main CPU 41 determines that a character selection signal is received (A6: YES), the terminal device administration table is updated (A7). Specifically, in the terminal device administration table, data indicating that the player-selected character is selected is stored in the data area of the terminal device number corresponding to the targeted terminal device 400 having output the character selection signal. Next, the character data and the associated voice pattern data are output (A8), and the process returns to A1. Specifically, the character data of the player-selected character indicated by the character selection signal is read out from the character memory 54 or RAM 43, and is output to the targeted terminal device 400. Meanwhile, voice pattern data associated with the character data of the player-selected character indicated by the character selection signal is read out from the voice pattern memory 56 or RAM 43, and is output to the targeted terminal device 400.

(Process Performed in Gaming Machine Terminal 2: Terminal End Process Routine)

Next described is a process routine performed in each terminal device 400 serving as a gaming machine terminal 2 of the gaming machine main body 1. When a terminal device 400 performs the terminal end process routine shown in FIG. 13, a terminal CPU 241 first performs a process of determining a selectable character (B1). This process is detailed later.

Next, the terminal CPU 241 displays, on the display 10B, a selectable character determined through the process of determining a selectable character, and waits for an entry of a player-selected character (B2).

The processes thereafter are waited until the entry of a player-selected character (B3: NO). Whether or not a character is selected is determined in B2, based on whether a portion of the touch panel 226 corresponding to a character image displayed on the display 101B is pressed.

In B3, if the terminal CPU 241 determines that a character is selected (B3: YES), a character selection signal indicating the player-selected character is output to the gaming machine main body 1 (B4). Next, character data and voice pattern data are received from the gaming machine main body 1 (B5). Next, the player-selected game is run (B6). Next, whether the game has ended is determined (B7). If the terminal CPU 241 determines that the game has ended (B7: YES), a game-end signal is output to the gaming machine main body 1 (B12), and the process returns to B1.

On the other hand, if the terminal CPU 241 determines that the game is not yet ended (B7: NO), the terminal CPU 241 determines whether there is a voice input to the microphone 227 (B8). If the terminal CPU 241 determines that there is no a voice input (B8: NO), the process returns to B6, and the game is continued (B6).

On the other hand, if the terminal CPU 241 determines that there is a voice input to the microphone (B8: YES), the voice input is output to the conversation engine circuit 228 (B9), and the conversation engine circuit 228 analyzes the voice. The terminal CPU 241 determines whether there is data to be output (B10) based on the result of the analysis performed by the conversation engine circuit 228. If the terminal CPU 241 determines that there is no data to be output (B10: NO), the process returns to B6, and the game is continued (B6). On the other hand, if the terminal CPU 241 determines that there is data to be output (B10: YES), the data to be output is output from the speaker 229 in the form of a voice having the voice pattern received (B11). Then, the process returns to B6, and the game is continued (B6).

Through the processes, it is possible to output from the speaker 229 a voice having the voice pattern associated with the selected character, based on an input to the microphone 227, in relation to the game running in the targeted terminal device 400.

(Process Performed in Gaming Machine Terminal 2: Selectable Character determination Routine)

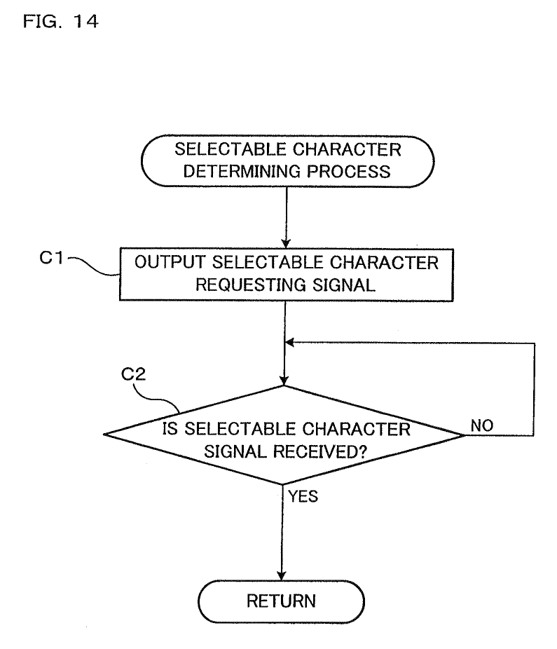

Next, the following describes with reference to FIG. 14 a routine of the selectable character determination called in the terminal end process routine. When the routine of the selectable character determination shown in FIG. 14 is executed, the terminal CPU 241 outputs a selectable game requesting signal to the gaming machine main body 1 (C1). Next, the terminal CPU 241 determines whether a selectable character signal is received (C2). Then, the subsequent process is waited until a reception of a selectable character signal (C2: NO). On the other hand, when the terminal CPU 241 determines that a selectable character signal is received (C2: YES), this routine is completed and the process returns to the terminal end process routine.

Further, the character selecting device requests the player to select a character from the plurality of characters respectively associated with different voice patterns. Next, the player-selected game is run. There is determined if a character is selected and what character is selected in each of the terminal devices. Based on the character selection status determined, the character selecting device requests the player to select a character other than those selected in the terminal devices. Based on an input to the microphone, information pieces stored in the character memory and voice pattern memory, and a game-running status, a voice having a selected voice pattern associated with a character is output from the speaker in relation to a game running in the targeted terminal device. Thus, the player is requested to select a character other than one selected in a terminal device within a predetermined distance from a terminal device to run a player-selected game, at the time of selecting a character from the plurality of characters. It is therefore possible to avoid outputting, from the speakers of these terminal devices, a game-related voice having an identical voice pattern associated with a single character. Thus, it is possible to provide a suitable gaming environment whereby players are not confused by game-related voices output at the same time in the same voice pattern. Thus, it is possible to provide a suitable gaming environment whereby players are not confused by outputting at the same time game-related voices having an identical voice pattern.

As described, the character selecting device requests the player to select a character from the plurality of characters respectively associated with different voice patterns. The targeted terminal device runs a game. There is determined if a character is selected and what character is selected in each of the terminal devices. Based on the character selection status determined and information stored in the terminal position memory, the character selecting device requests the player to select a character other than one selected in a terminal device located within the predetermined distance from a terminal device for running therein the player-selected game. Based on an input to the microphone, information pieces stored in the character memory and voice pattern memory, and a game-running status, a voice having a selected voice pattern associated with a character is output from the speaker in relation to a game running in the targeted terminal device. Thus, the player is requested to select a character other than one selected in a terminal device within a predetermined distance from a terminal device to run a player-selected game, at the time of selecting a character from the plurality of characters. It is therefore possible to avoid outputting, from speakers located within a predetermined distance from each other, a game-related voice having an identical voice pattern associated with a single character. Thus, it is possible to provide a suitable gaming environment whereby players are not confused by outputting within a predetermined distance game-related voices having an identical voice pattern at the same time. Further, voice patterns are respectively associated with characters. This enables the player to easily make his/her selection of a voice pattern. Further, speakers located within a predetermined distance from each other are prohibited from outputting a game-related voice having an identical voice pattern associated with a single character at the same time, a game-related voice having the same voice pattern can be output at the same time from a speaker outside of the predetermined distance. The player therefore is provided with a larger selection of selectable characters, and more enjoyable gaming environment.

### Embodiment 2

The following describes a gaming device related to Embodiment 2 of the present invention, and an embodiment of a playing method of the gaming device. Note that same symbols are given to members identical to those of Embodiment 1, and explanation therefor are omitted here.

As shown in FIG. 1, a gaming device executes a playing method including: a stage for determining, based on an input to the microphone 227 of a terminal device 400 (hereinafter, targeted terminal device), if a character is selected and which one of the character is selected in a terminal device 400 located within such a distance that a game-related voice output from the terminal device 400 can reach the microphone 227 of a targeted terminal device 400 (such a distance is hereinafter referred to as a voice-reachable distance); a stage for requesting, based on the result of the stage for determining, the player to select through a character selecting device 111 a character other than one selected in a terminal device 400 located within the voice-reachable distance; and a stage for outputting, from a speaker 229, a voice having a voice pattern associated with a player-selected character, based on an input to the microphone 227, in relation to a player-selected game running in the targeted terminal device 400.

As shown in FIG. 2, the controller 100 includes: the terminal device control unit 112; the selected-character determining unit 113; the voice-input determining unit 116; an output-voice determining unit 117; and the character selecting device control unit 118.

(Configuration of Controller 200)

The controller 200 is configured so as to execute: a fourth process for determining, based on an input to the microphone 227 of a terminal device 400 (hereinafter, targeted terminal device), if a character is selected and which one of the character is selected in a terminal device 400 located within such a distance that a game-related voice output from the terminal device 400 can reach the microphone 227 of a targeted terminal device 400 (such a distance is hereinafter referred to as a voice-reachable distance); a fifth process for requesting, based on the result of the stage for determining, the player to select through a character selecting device 111 a character other than one selected in a terminal device 400 located within the voice-reachable distance; and a third process for outputting, from a speaker 229, a voice having a voice pattern associated with a player-selected character, based on an input to the microphone 227, in relation to a player-selected game running in the targeted terminal device 400. In other words, the controller 200 includes a third process unit, a fourth process unit, and a fifth process unit.

(Operation of Controller 200)

The following describes an operation of the controller 200 having the above mentioned configuration. First, the voice-input determining unit 116 determines which one of the characters relates to the voice pattern of voice data having been input to the microphone 227. Then, the output-voice determining unit 117 outputs the result to the selected-character determining unit 113. The selected-character determining unit 113 determines that the character which is recognized as to relate to the voice as a result of the determination performed by the output-voice determining unit 117 is selected in a terminal device 400 located within the voice-reachable distance. Through the processes, the controller 200 performs the fifth process for determining if a character is selected and what character is selected in a terminal device 400 located within the voice-reachable distance, based on an input to the microphone 227 of the targeted terminal device 400.

Further, based on the result of the fourth process, the character data in the character memory 54, and the voice pattern data in the voice pattern memory 56, the selected-character determining unit 113 specifies a character which is not related to the character recognized as to relate to the voice as a result of the determination performed by the output-voice determining unit 117. As described, based on the result of the above determination, the controller 200 performs the fifth process for requesting the player to select through a character selecting device 111 a character other than one selected in a terminal device 400 located within the voice-reachable distance.

The character selecting device control unit 118 outputs to the terminal device control unit 112 data indicating a character selected through the character selecting device 111. The terminal device control unit 112 reads out from the character memory 54 character data related to the player-selected character which is input from the character selecting device control unit 118. Further, the terminal device controlling unit 112 reads out, from the voice pattern memory 56, voice pattern data associated with the player-selected character. The terminal device control unit 112 outputs the read out character data and voice pattern data to the targeted terminal device 400.

The voice-input determining unit 116 determines if voice data input to the microphone 227 relates to a voice pattern associated with any of the characters and if the voice data corresponds to a game being run by the game running unit 110. Then, the voice-input determining unit 116 outputs the result to the output-voice determining unit 117. The output-voice determining unit 117 then determines a reply to the voice input, and outputs the reply from the speaker 229 in a voice having the voice pattern associated with the selected character. In this way, the controller 200 performs the third process for outputting, from a speaker 229, a voice having a voice pattern associated with a player-selected character, based on an input to the microphone 227, in relation to a player-selected game running in the targeted terminal device 400.

As is obvious from the above processes, a gaming device executes a playing method including: a stage for determining, based on an input to the microphone 227 of a terminal device 400 (hereinafter, targeted terminal device), if a character is selected and which one of the character is selected in a terminal device 400 located within such a distance that a game-related voice output from the terminal device 400 can reach the microphone 227 of a targeted terminal device 400 (such a distance is hereinafter referred to as a voice-reachable distance); a stage for requesting, based on the result of the stage for determining, the player to select through a character selecting device 111 a character other than one selected in a terminal device 400 located within the voice-reachable distance; and a stage for outputting, from a speaker 229, a voice having a voice pattern associated with a player-selected character, based on an input to the microphone 227, in relation to a player-selected game running in the targeted terminal device 400.

With the above playing method, the character selecting device requests the player to select a character from the plurality of characters respectively associated with different voice patterns. The targeted terminal device runs a game. Based on an input to the microphone and information in the voice pattern memory and character memory, there is determined if a character is selected and what character is selected in a terminal device located within the voice-reachable distance. Based on the character selection status determined, the character selecting device only allows the player to select a character other than one selected in a terminal device located within the voice-reachable distance. Based on an input to the microphone, information pieces stored in the character memory and voice pattern memory, and a game-running status, a voice having a selected voice pattern associated with a character is output from the speaker in relation to a game running in the targeted terminal device. Thus, the player is requested to select a character other than one selected in a terminal device located within the voice-reachable distance, at the time of selecting a character from the plurality of characters. It is therefore possible to avoid outputting, from speakers located within the voice-reachable distance from each other, a game-related voice having an identical voice pattern associated with a single character. Thus, it is possible to provide a suitable gaming environment whereby players are not confused by outputting, within the voice-reachable distance, game-related voices having an identical voice pattern at the same time. Further, voice patterns are respectively associated with characters. This enables the player to easily make his/her selection of a voice pattern. Although speakers located within the voice-reachable from each other are prohibited from outputting game-related voices having an identical voice pattern associated with a single character at the same time, a game-related voice having the same voice pattern can be output at the same time from a speaker outside of the predetermined distance. The player therefore is provided with a larger selection of selectable characters, and more enjoyable gaming environment. Further, since speakers within the voice-reachable distance from each other are prohibited from outputting game-related voices having an identical voice pattern associated with a single character, the selection of characters provided to the player is more appropriately increased. This is advantageous in that there is no need for setting such a distance that speakers located within the distance from each other are prohibited from outputting game-related voices having an identical voice pattern associated with a single character. As a result, more enjoyable gaming environment is provided.

(Gaming Device and Flow of Playing Method)

The explanation for the gaming device and the playing method thereof are omitted as they are the same as those described in Embodiment 1.

(Relation between Selected Character and Selectable Character)

The following describes a relation between a selected character and a selectable character. In Embodiment 2, the plurality of different characters are the following three characters: “Hog”, “Haduki”, and “Don”. Further, the plurality of terminal devices 400 are provided. Note that the targeted terminal device 400 for running a player-selected game outputs from its speaker 229 a game-related voice having the voice pattern associated with the player-selected character.

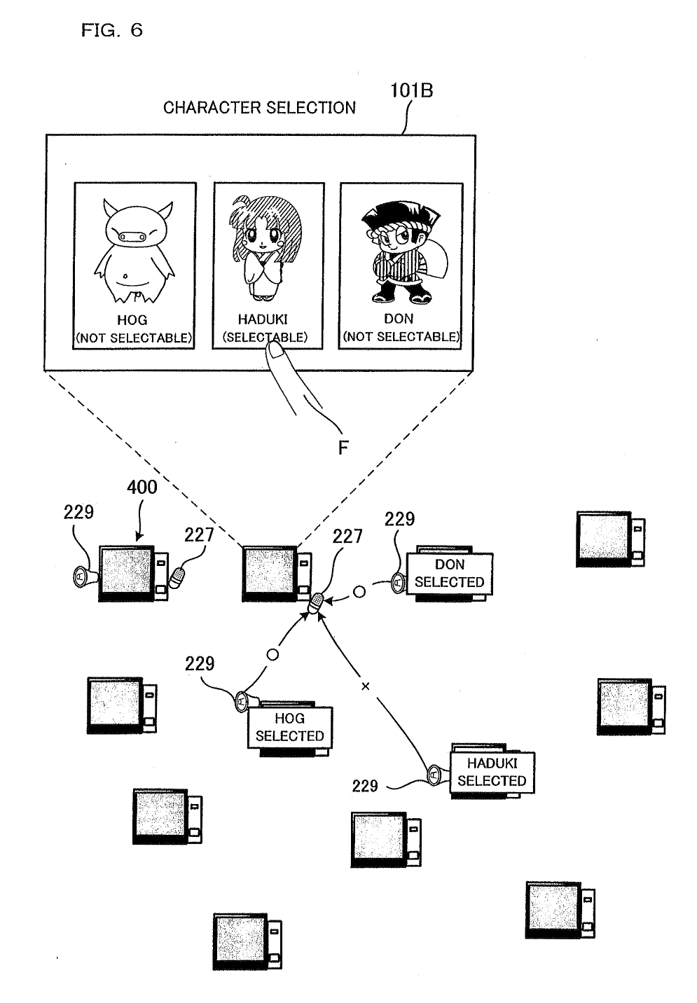

Further, the gaming device of the present embodiment shown in FIG. 6 includes: the microphone 227 and the speaker 229. As shown in FIG. 6, “Hog” is selected in one terminal device 400. “Haduki” is selected in another terminal device 400. “Don” is selected in yet another terminal device 400. Note that the targeted terminal device 400 for running a player-selected game outputs from its speaker 229 a voice having the voice pattern associated with the player-selected character, in relation to the running game. A game-related voice from the speaker 229 of the terminal device 400 in which “Hog” is selected is input to the microphone 227 of the targeted terminal device 400 for accepting an entry of a player-selected character and running a player selected game. A game-related voice from the speaker 229 of the terminal device 400 in which “Don” is selected is input to the microphone 227 of the targeted terminal device 400 for accepting an entry of a player-selected character and running a player selected game. A game-related voice from the speaker 229 of the terminal device 400 in which “Haduki” is selected is not input to the microphone 227 of the targeted terminal device 400 for accepting an entry of a player-selected character and running a player selected game. In this case, “Hog” and “Don” are not selectable while “Haduki” is selectable, in the targeted terminal device 400 for accepting an entry of a player-selected character and running a player selected game. In other words, the player is not able to select a character selected in a terminal device 400 located within the voice-reachable distance. As described, the gaming device only allows the player to select a character other than one selected in a terminal device 400 located within the voice-reachable distance. Note that the targeted terminal device 400 for accepting an entry of a player-selected character outputs from its speaker 229 a game-related voice having the voice pattern associated with the player-selected character.

Thus, the player is requested to select a character other than one selected in a terminal device located within the voice-reachable distance, at the time of selecting a character from the plurality of characters. It is therefore possible to avoid outputting, from speakers located within the voice-reachable distance from each other, a game-related voice having an identical voice pattern associated with a single character. Accordingly, it is possible to provide a suitable gaming environment whereby players are not confused by outputting, within the voice-reachable distance, game-related voices having an identical voice pattern at the same time. Further, voice patterns are respectively associated with characters. This enables the player to easily make his/her selection of a voice pattern. Although speakers located within the voice-reachable from each other are prohibited from outputting game-related voices having an identical voice pattern associated with a single character at the same time, a game-related voice having the same voice pattern can be output at the same time from a speaker outside of the predetermined distance. The player therefore is provided with a larger selection of selectable characters, and more enjoyable gaming environment. Further, since speakers within the voice-reachable distance from each other are prohibited from outputting game-related voices having an identical voice pattern associated with a single character, the selection of characters provided to the player is more appropriately increased. This is advantageous in that there is no need for setting such a distance that speakers located within the distance from each other are prohibited from outputting game-related voices having an identical voice pattern associated with a single character. As a result, more enjoyable gaming environment is provided.

(Mechanical and Electric Configurations of Gaming Device)

Explanations for the mechanical and electrical configurations of the gaming device of Embodiment 2 is omitted as they are the same as those of Embodiment 1.

(Character Data Table)

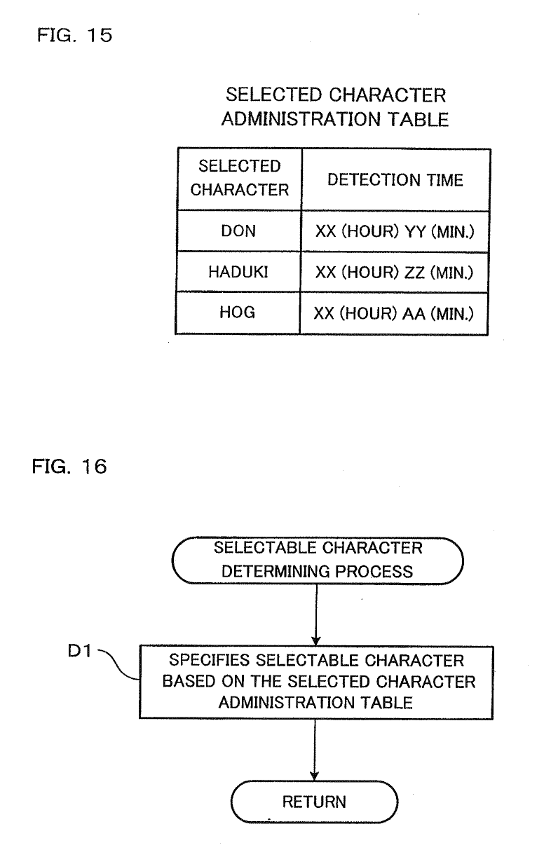

The RAM 243 of each terminal device 400 stores therein a selected character administration table as shown in FIG. 15. The selected game administration table is a table for administrating characters selected in terminal devices 400 located within the voice-reachable distance. The selected character administration table is stored in each of the terminal devices 400. The selected character administration table includes at least: a list of selected characters; and a list of detection times. The list of selected characters is a list of data indicating the names of characters. The list of detection times is a list of data items each indicating a time of detecting a game running in another terminal device 400.

More specifically, the running game administration table of FIG. 15 indicates that a state where “Don” is selected is detected at XX (hour): YY (min). Further, the table indicates that a state where “Haduki” is selected is detected at XX (hour): ZZ (min). Further, the table indicates that a state where “Hog” is selected is detected at XX (hour): AA (min).

Note that the selectable character administration table is not limited to the one described in the present embodiment, provided that character selected within the voice-reachable distance are stored.

(Process Performed in Gaming Machine Terminal 2: Selectable Character determination Routine)

Next, the following describes a routine of a selectable character determination of Embodiment 2, with reference to FIG. 16. The routine of the selectable game determination is called during the terminal end process routine. When the routine of the selectable game determination is executed, the terminal CPU 241 specifies a selectable character based on the selectable character administration table (D1). Then, the process returns to the terminal end process routine. Specifically, specified as a selectable character is a character which is not in the selected character administration table.

(Process Performed in Gaming Machine Terminal 2: Selected Character determination Routine)

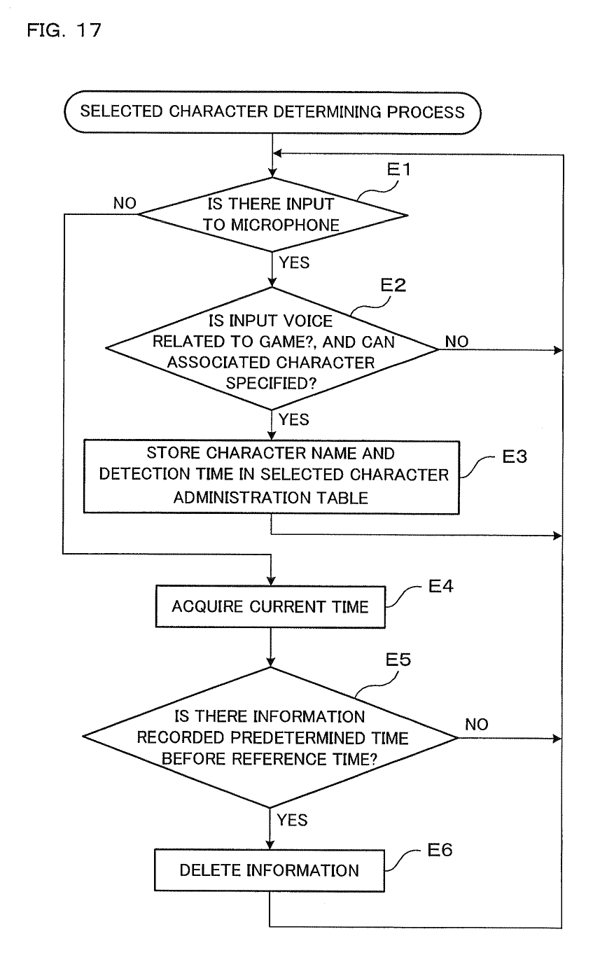

Next, the following describes a routine of a selected character determination, with reference to FIG. 17. This routine of the selected character determination is always executed by the terminal CPU 241, independently from the other routines. This routine of the selected character determination is always executed by the terminal CPU 241, independently from the other routines. If the terminal CPU 241 determines that there is an input to the microphone 227 (E1: YES), the terminal CPU 241, through the conversation engine circuit 228, determines whether the input to the microphone 227 is a voice related to a game, specifies the voice pattern from the voice, and determines whether character of the voice pattern is specified (E2). If the terminal CPU 241 determines that the input is a voice related to a game and that the character is specified (E2: YES), the name of the character and the time of detecting the character is stored in the running game administration table (E3). The process then returns to E1.

On the other hand in E1, if the terminal CPU 241 determines that no a voice is input to the microphone 227 (E1: NO), the current time is acquired (E4). Next, the terminal CPU 241 sets the current time as a reference time, and determines if the selected character administration table contains information recorded a predetermined time before the reference time (E5). If the terminal CPU 241 determines that there is information recorded the predetermined time before the reference time (E5: YES), the terminal CPU 241 deletes the information (E6). The process then returns to E1. On the other hand, if the terminal CPU 241 determines that there is no information recorded the predetermined time before the reference time (E5: NO), the process returns to E1.

Further, the character selecting device requests the player to select a character from the plurality of characters respectively associated with different voice patterns. The targeted terminal device runs a game. Based on an input to the microphone and information in the voice pattern memory and character memory, there is determined if a character is selected and what character is selected in a terminal device located within the voice-reachable distance. Based on the character selection status determined, the character selecting device only allows the player to select a character other than one selected in a terminal device located within the voice-reachable distance. Based on an input to the microphone, information pieces stored in the character memory and voice pattern memory, and a game-running status, a voice having a selected voice pattern associated with a character is output from the speaker in relation to a game running in the targeted terminal device. Thus, the player is requested to select a character other than one selected in a terminal device located within the voice-reachable distance, at the time of selecting a character from the plurality of characters. It is therefore possible to avoid outputting, from speakers located within the voice-reachable distance from each other, a game-related voice having an identical voice pattern associated with a single character. Thus, it is possible to provide a suitable gaming environment whereby players are not confused by outputting, within the voice-reachable distance, game-related voices having an identical voice pattern at the same time. Further, voice patterns are respectively associated with characters. This enables the player to easily make his/her selection of a voice pattern. Although speakers located within the voice-reachable from each other are prohibited from outputting game-related voices having an identical voice pattern associated with a single character at the same time, a game-related voice having the same voice pattern can be output at the same time from a speaker outside of the predetermined distance. The player therefore is provided with a larger selection of selectable characters, and more enjoyable gaming environment. Further, since speakers within the voice-reachable distance from each other are prohibited from outputting game-related voices having an identical voice pattern associated with a single character, the selection of characters provided to the player is more appropriately increased. This is advantageous in that there is no need for setting such a distance that speakers located within the distance from each other are prohibited from outputting game-related voices having an identical voice pattern associated with a single character. As a result, more enjoyable gaming environment is provided.

### Embodiment 3

The following describes a gaming device related to Embodiment 3 of the present invention, and an embodiment of a playing method of the gaming device. Note that same symbols are given to members identical to those of Embodiment 1, and explanation therefor are omitted here.

A gaming device of Embodiment 3 only includes gaming machine terminal 2 of the gaming device in Embodiment 2. That is, a single gaming device stores therein a plurality of characters and voice patterns respectively associated with the characters, requests a player to select a character through the character selecting device 111, and executes an effect using the selected character. In the present embodiment, at least two of these gaming devices are installed in a game arcade.

As shown in FIG. 1, a gaming device executes a playing method including: a stage for determining, based on an input to the microphone 30 of a gaming device (hereinafter, targeted terminal device), if a character is selected and which one of the character is selected in another gaming device located within such a distance that a game-related voice output from the other gaming device can reach the microphone 30 of a targeted gaming device (such a distance is hereinafter referred to as a voice-reachable distance); a stage for requesting, based on the result of the stage for determining, the player to select through a character selecting device 111 a character other than those selected in the other gaming device located within the voice-reachable distance; and a stage for outputting, from a speaker 29, a voice having a voice pattern associated with a player-selected character, in relation to a player-selected game running, based on an input to the microphone 30 and a game-running status.

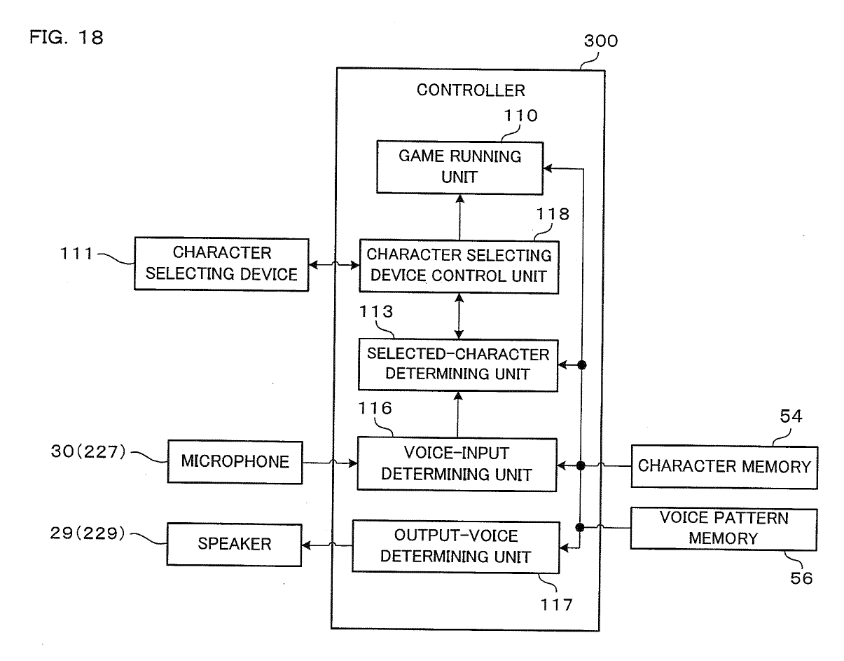

As shown in FIG. 18, the controller 300 includes: a selected-character determining unit 113; a voice-input determining unit 116; an output-voice determining unit 117; a character selecting device control unit 118; and a game running unit 110.

(Configuration of Controller 300)

A gaming device is configured so as to execute: a sixth process for determining, based on an input to the microphone 30 of a gaming device (hereinafter, targeted terminal device), if a character is selected and which one of the character is selected in another gaming device located within such a distance that a game-related voice output from the other gaming device can reach the microphone 30 of a targeted gaming device (such a distance is hereinafter referred to as a voice-reachable distance); a seventh process for requesting, based on the result of the stage for determining, the player to select through a character selecting device 111 a character other than those selected in the other gaming device located within the voice-reachable distance; and a third process for outputting, from a speaker 29, a voice having a voice pattern associated with a player-selected character, in relation to a player-selected game running, based on an input to the microphone 30 and a game-running status. In other words, the controller 200 includes the third process unit, the sixth process unit, and a seventh process unit.

(Operation of Controller 300)

The following describes an operation of the controller 300 having the above mentioned configuration. First, the voice-input determining unit 116 determines which one of the characters relates to the voice pattern of voice data having been input to the microphone 30 as shown in FIG. 18. Then, the output-voice determining unit 117 outputs the result to the selected-character determining unit 113. The selected-character determining unit 113 determines that the character recognized as to relate to the voice as the result of determination performed by the output-voice determining unit 117 is selected in another gaming device located within the voice-reachable distance. As described, the controller 300 performs the seventh process for determining, based on an input to the microphone 30 of a gaming device, if a character is selected and what character is selected in a gaming device located within the voice-reachable distance.

As shown in FIG. 18, based on the result of the sixth process, the selected-character determining unit 113 specifies a character which is not related to the character recognized as to relate to the voice as a result of the determination performed by the output-voice determining unit 117. As described, based on the result of the above determination, the controller 300 performs the seventh process for requesting the player to select through a character selecting device 111 a character other than those selected in another gaming device located within the voice-reachable distance.

Further, as shown in FIG. 18, the controller 300 executes an effect using the selected character and causes the game running unit 110 to run the player-selected game.

First, as shown in FIG. 18, the voice-input determining unit 116 determines which one of the characters relates to the voice pattern of voice data having been input to the microphone 30. The output-voice determining unit 117 then determines a reply to the voice input, and outputs the reply from the speaker 29 in a voice having the voice pattern associated with the selected character. In this way, the controller 300 performs the third process for outputting, from a speaker 29, a voice having a voice pattern associated with a player-selected character, based on an input to the microphone 30, in relation to a player-selected game running in the targeted terminal device 400.

As is obvious from the above processes, a gaming device realizes a playing method including: a stage for determining, based on an input to the microphone 30 of a gaming device (hereinafter, targeted terminal device), if a character is selected and which one of the character is selected in another gaming device located within such a distance that a game-related voice output from the other gaming device can reach the microphone 30 of a targeted gaming device (such a distance is hereinafter referred to as a voice-reachable distance); a stage for requesting, based on the result of the stage for determining, the player to select through a character selecting device 111 a character other than those selected in the other gaming device located within the voice-reachable distance; and a stage for outputting, from a speaker 29, a voice having a voice pattern associated with a player-selected character, in relation to a player-selected game running, based on an input to the microphone 30 and a game-running status.

With the above playing method, the character selecting device requests the player to select a character from the plurality of characters respectively associated with different voice patterns. Based on an input to the microphone and information in the voice pattern memory and character memory, there is determined if a character is selected and what character is selected in a gaming device located within the voice-reachable distance. Based on the character selection status determined, the character selecting device only allows the player to select a character other than those selected in a gaming device located within the voice-reachable distance. Based on an input to the microphone, information pieces stored in the character memory and voice pattern memory, and a game-running status, a voice having a selected voice pattern associated with a character is output from the speaker in relation to a game running. Thus, the player is requested to select a character other than one selected in a gaming device located within the voice-reachable distance, at the time of selecting a character from the plurality of characters. It is therefore possible to avoid outputting, from speakers located within the voice-reachable distance from each other, a game-related voice having an identical voice pattern associated with a single character. Thus, it is possible to provide a suitable gaming environment whereby players are not confused by outputting, within the voice-reachable distance, game-related voices having an identical voice pattern at the same time. Further, voice patterns are respectively associated with characters. This enables the player to easily make his/her selection of a voice pattern. Although speakers located within the voice-reachable from each other are prohibited from outputting game-related voices having an identical voice pattern associated with a single character at the same time, a game-related voice having the same voice pattern can be output at the same time from a speaker outside of the predetermined distance. The player therefore is provided with a larger selection of selectable characters, and more enjoyable gaming environment. Further, since speakers within the voice-reachable distance from each other are prohibited from outputting game-related voices having an identical voice pattern associated with a single character, the selection of characters provided to the player is more appropriately increased. This is advantageous in that there is no need for setting such a distance that speakers located within the distance from each other are prohibited from outputting game-related voices having an identical voice pattern associated with a single character. As a result, more enjoyable gaming environment is provided.

(Gaming Device and Flow of Playing Method)

The explanation for the gaming device and the playing method thereof are omitted as they are the same as those described in Embodiment 1.

(Relation between Selected Character and Selectable Character)

The following describes a relation between a selected character and a selectable character. In Embodiment 2, the plurality of different characters are the following three characters: “Hog”, “Haduki”, and “Don”. In the following provides an explanation with the terminal device 400 of FIG. 6 being replaced with “gaming device”. Note that the targeted gaming device for running a player-selected game outputs from its speaker 229 a game-related voice having the voice pattern associated with the player-selected character. Further, the gaming device includes a microphone 30 for receiving a voice input.

Further, the gaming device of the present embodiment shown in FIG. 6 includes: a microphone 30 and a speaker 29. As shown in FIG. 6, “Hog” is selected in one terminal device 400. “Haduki” is selected in another gaming device. “Don” is selected in yet another gaming device. Note that the targeted gaming device for running a player-selected game outputs from its speaker 229 a voice having the voice pattern associated with the player-selected character, in relation to the running game. A game-related voice from the speaker 229 of the gaming device in which “Hog” is selected is input to the microphone 227 of the targeted gaming device for accepting an entry of a player-selected character and running a player selected game. A game-related voice from the speaker 229 of the gaming device in which “Hog” is selected is input to the microphone 227 of the targeted gaming device for accepting an entry of a player-selected character and running a player selected game. A game-related voice from the speaker 229 of the gaming device in which “Haduki” is selected is not input to the microphone 227 of the targeted gaming device for accepting an entry of a player-selected character and running a player selected game. In this case, “Hog” and “Don” are not selectable while “Haduki” is selectable, in the targeted gaming device for accepting an entry of a player-selected character and running a player selected game. In other words, the player is not able to select a character selected in a gaming device located within the voice-reachable distance. As described, the gaming device only allows the player to select a character other than those selected in a gaming device located within the voice-reachable distance. Note that the targeted gaming device for accepting an entry of a player-selected character outputs from its speaker 229 a game-related voice having the voice pattern associated with the selected character.

(Mechanical and Electric Configurations of Gaming Device)

Mechanical and electrical configuration of the gaming device of Embodiment 3 is the same as those of the terminal device 400 described in Embodiment 2, except in that a character memory 54 and a voice pattern memory 56 are added.

In this way, the character selecting device requests the player to select a character from the plurality of characters respectively associated with different voice patterns. Based on an input to the microphone and information in the voice pattern memory and character memory, there is determined if a character is selected and what character is selected in another gaming device located within the voice-reachable distance. Based on the character selection status determined, the character selecting device only allows the player to select a character other than those selected in a gaming device located within the voice-reachable distance. Based on an input to the microphone, information pieces stored in the character memory and voice pattern memory, and a game-running status, a voice having a selected voice pattern associated with a character is output from the speaker in relation to a game running. Thus, the player is requested to select a character other than one selected in a gaming device located within the voice-reachable distance, at the time of selecting a character from the plurality of characters. It is therefore possible to avoid outputting, from speakers located within the voice-reachable distance from each other, a game-related voice having an identical voice pattern associated with a single character. Thus, it is possible to provide a suitable gaming environment whereby players are not confused by outputting, within the voice-reachable distance, game-related voices having an identical voice pattern at the same time. Further, voice patterns are respectively associated with characters. This enables the player to easily make his/her selection of a voice pattern. Although speakers located within the voice-reachable from each other are prohibited from outputting game-related voices having an identical voice pattern associated with a single character at the same time, a game-related voice having the same voice pattern can be output at the same time from a speaker outside of the predetermined distance. The player therefore is provided with a larger selection of selectable characters, and more enjoyable gaming environment. Further, since speakers within the voice-reachable distance from each other are prohibited from outputting game-related voices having an identical voice pattern associated with a single character, the selection of characters provided to the player is more appropriately increased. This is advantageous in that there is no need for setting such a distance that speakers located within the distance from each other are prohibited from outputting game-related voices having an identical voice pattern associated with a single character. As a result, more enjoyable gaming environment is provided.

The detailed description of the present invention provided hereinabove mainly focused on characteristics thereof for the purpose of easier understanding; however, the scope of the present invention shall be construed as broadly as possible, encompassing various forms of other possible embodiments, and therefore the present invention shall not be limited to the above description. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in the present specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, sufficient reference to documents which are already disclosed is strongly encouraged.

In addition, the detailed description of the present invention provided hereinabove includes a process executed on a computer or computer network. The above descriptions and expressions have been provided to allow the one skilled in the art to most efficiently understand the invention. In the specification, the respective steps used to derive one result or blocks having a predetermined processing function should be understood as a process free of self-contradiction. Further, the electrical or magnetic signal is transmitted/received and written in the respective steps or blocks. It should be note that such a signal is expressed in the form of bit, value, character, term, number, or the like solely for the sake of convenience. Further, although the processes in the respective steps or blocks have been often described as an expression common to a human action; however, the process described in the specification is executed by a variety of devices in principle. Further, the other structures necessary for the respective steps or blocks are obvious from the above descriptions.

What is claimed is:

1. A gaming device comprising:
a voice pattern memory which stores therein a plurality of different voice patterns;
a character memory which stores therein a plurality of characters related to the games, the characters respectively associated with the voice patterns;
a speaker which outputs a voice related to the games to the outside;
a microphone which receives a voice externally input;
a plurality of terminal devices which runs therein a game;
a character selecting device which allows a player to select a character;
a controller which is programmed to perform the processes of:
(a1) determining if a character is selected and what character is selected in each of the terminal devices;
(a2) requesting the player to select through the character selecting device a character other than those being selected in the terminal devices, based on a result of (a1);
(a3) outputting from a speaker a voice having a voice pattern associated with a selected character, in relation to a game running in the targeted terminal device, based on an input to the microphone, information pieces stored in the character memory and voice pattern memory, and a game-running status.

2. A gaming device comprising:
a voice pattern memory which stores therein a plurality of different voice patterns;
a character memory which stores therein a plurality of characters related to the games, the characters respectively associated with the voice patterns;
a plurality of terminal devices which runs the games, and each of which includes a speaker for outputting voices related to the games, and a microphone for receiving voice externally input;
a character selecting device which allows a player to select a character in one of the terminal devices;
a terminal position memory which stores a position of each of the terminal devices;
a controller which is programmed to perform the processes of:
(b1) determining if a character is selected and what character is selected in each of the terminal devices;
(b2) requesting the player to select a character other than one selected in a terminal device located within a predetermined distance from the targeted terminal device for running the player-selected game, based on a result of (b1) and information stored in the terminal position memory;
(b3) outputting from a speaker a voice having a voice pattern associated with a selected character, in relation to a game running in the targeted terminal device, based on an input to the microphone, information pieces stored in the character memory and voice pattern memory, and a game-running status.

3. A gaming device comprising:
a voice pattern memory which stores therein a plurality of different voice patterns;
a character memory which stores therein a plurality of characters related to the games, the characters respectively associated with the voice patterns;
a plurality of terminal devices which runs the games, and each of which includes a speaker for outputting voices related to the games, and a microphone for receiving voice externally input;
a character selecting device which allows a player to select a character;
a controller which is programmed to perform the processes of:
(c1) determining if a character is selected and what character is selected in a terminal device located within a voice-reachable distance, based on an input to the microphone and information stored in the voice pattern memory and character memory;
(c2) requesting the player to select through the character selecting device a character other than one selected in a terminal device located within the voice-reachable distance, based on a result of (c1);
(c3) outputting from a speaker a voice having a voice pattern associated with a selected character, in relation to a game running in the targeted terminal device, based on an input to the microphone, information pieces stored in the character memory and voice pattern memory, and a game-running status.

4. A gaming device comprising:
a voice pattern memory which stores therein a plurality of different voice patterns;
a character memory which stores therein a plurality of characters related to the games, the characters respectively associated with the voice patterns;
a speaker which outputs a voice related to the games to the outside;
a microphone which receives a voice externally input;
a character selecting device which allows a player to select a character;
a controller which is programmed to perform the processes of:
(d1) determining if a character is selected and what character is selected in a gaming device located within a voice-reachable distance, based on an input to the microphone and information stored in the voice pattern memory and character memory;
(d2) requesting the player to select through the character selecting device a character other than one selected in a gaming device located within the voice-reachable distance, based on a result of (d1);
(d3) outputting a voice having a voice pattern associated with a selected character, in relation to a game running in the targeted terminal device, based on an input to the microphone, information pieces stored in the character memory and voice pattern memory, and a game-running status.

5. A playing method of a gaming device by which games are run in a plurality of terminal devices, the method comprising the steps of:
(e1) determining if a character is selected and what character is selected in each of the terminal devices;
(e2) requesting the player to select a character other than those being selected in the terminal devices, based on a result of (e1);
(e3) running the player-selected character game in the targeted terminal devices;
(e4) outputting from the speaker a voice having a voice pattern associated with a selected character, in relation to the game to be run in the targeted terminal device, based on an input to the microphone.
